(19) United States
(12) Patent Application Publication
(10) Pub. No.: US 2002/0161561 A1
(43) Pub. Date: Oct. 31, 2002

(54) System and method for association of object sets

(76) Inventors: Sridevi Sarma, Cambridge, MA (US); Sean Warnick, Cambridge, MA (US); Munther A. Dahleh, Cambridge, MA (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/051,548

(22) Filed: Jan. 16, 2002

Related U.S. Application Data
(60) Provisional application No. 60/262,200, filed on Jan. 16, 2001.
(60) Provisional application No. 60/349,635, filed on Jan. 16, 2002.

(51) Int. Cl. G06F 17/10

(52) U.S. Cl. 703/2

(57) ABSTRACT

In the context of associations between sets of objects, such as between two categorical data sets, a system and method of performing associations and determining optimizations thereof is presented. Performing various modifications of original object sets, such as by aggregating, refining and permuting the elements of the original object sets yield modified object sets corresponding to the original object sets. Functions and metrics are performed on the object sets, such as by calculating pair association values and overall association values to evaluate the strength or adequacy of an association. A process which iteratively modifies and re-evaluates the resulting associations of modified object sets is described, optionally checking for consistency or convergence of the result, optionally onto an optimum result and optionally checking a stopping criterion for terminating the process.

### RELATED APPLICATIONS

The present application claims the benefit, under 35 U.S.C. §119(e), of U.S. Provisional Patent Application, Serial No. 60/262,200, filed Jan. 16, 2001, and entitled “Identification of Multi-Resolution Correspondence in Interactive Data Sets by Iterative Refinement” which is hereby incorporated by reference. This application is also related to U.S. Provisional Patent Application, Serial No. unassigned, bearing Attorney Docket No. F00526/70004, entitled “Performance-Driven Association Modeling From Categorical Data,” filed on even date herewith, which is hereby incorporated by reference.

### TECHNICAL FIELD

The present invention relates to association modeling as applied to more than one set of objects.

### BACKGROUND

The idea of relating the elements of two sets to one another is sometimes referred to as “matching” or “associating” the elements of the sets to one another. Pairs of elements, taken from the two sets, can be associated element-by-element, optionally yielding “pair association values” which describe the strength or adequacy of the association. Two sets can also be associated in a global sense, for example after associating all of the corresponding elements of the two sets, optionally yielding an “overall association value,” indicative of the strength or adequacy of the overall global match between the two sets. The overall association value may be a function of the pair association values.

A typical assignment problem in the art of “matching theory” considers the association between two sets of objects such that every element in one object set is matched to one and only one element from the other set. The objective of this problem is to find an admissible association between all objects of the two sets such that the overall association value is maximized. For example, consider the problem of assigning 10 people to 10 tasks, where the objective is to match each person to a unique task such that the overall association value is as large as possible. Here, the pair association value for matching person i to task j may indicate the value person i would generate for the organization each day if assigned to task j. In the typical assignment problem, the pair association values are often known apriori. Lovasz discusses some of these concepts generally in Matching Theory, North Holland Press, 1986.

There exist many applications, however, wherein two object sets must be associated to one another without having prior knowledge to some or all pair association values. In such cases, data is often collected to estimate these quantities. The art of inferring properties of an unknown distribution of quantities from data generated by that distribution is called “statistical inference of data”. All statistical inference problems must deal with the issues of lacking sufficient and/or relevant data to guarantee accuracy and consistency in the quantities being estimated. A typical approach to overcome such limitations is to describe the quantities being estimated at a coarser level, so instead of estimating how often French Fries are bought with a Big Mac, one estimates how often a side item is bought with any type of burger. This is the notion of “aggregation” or “clustering”. These concepts are discussed generally in A Probabilistic Theory of Pattern Recognition, by Devroye et al., Springer-Verlag, 1996.

Aggregation is just one of the many operations performed on data sets for the purpose of extracting meaningful information. The overlapping fields of Knowledge Discover From Data, Data Mining, and On Line Analytical Processing encompass the many functions including drilling, classification, comparison, characterization described in “Advances in Knowledge Discover and Data Mining”, edited by Fayyad et al.

One application that requires both matching and inferring quantities from data includes “one-to-one marketing” or “personalization”, where businesses are required to match their customers to products either at an individual level or at a segment level to increase sales. Primarily marketing and retail operations aim to satisfy the individual needs of a customer by studying to the customer's past behavior and profile. It has also been recognized that a match or association between two data sets may be optimized. A narrow field of art, sometimes known as “matching theory,” has developed around determining the optimal association of data sets. If a desired outcome is known to exist, then two sets can be matched, or their elements arranged element-wise until the optimum outcome is attained. Sometimes this involves permuting the order of two sets until the optimum association configuration is achieved. Similarly, if the optimum association is not made, then an association satisfying some requirement or criterion can be admitted.

A related field of art is that of “personalization,” wherein primarily marketing and retail operations aim to satisfy the recognized individual needs of an individual customer by studying and catering to the customer's needs and preferences in order to increase sales to the customer. This field is sometimes known as “one-to-one marketing.”

Some attempts have been made to achieve useful results from matching customers with commercial offerings, presented for example over the Internet in an electronic commerce framework. Online retailers and vendors have long recognized the value of setting up a customized front end corresponding to characteristics of a customer and choices made by the customer from a recorded customer history or “profile.” World Wide Web (“web”) sites such as Yahoo!, Amazon.com and others set up personal “profiles” for their customers, such that each customer has a set of stored attributes, associated with the customer, that determine the content presented to the customer. The profiles normally consist of parameters and descriptors stored in a database. Often, a customer determines the nature of its profile by entering data or making selections at the time the customer opens an account or signs up with the service provider or vendor. In other instances, data may be collected about the customer from indirect sources, such as marketing databases.

It is common for a customer to be presented with marketing materials, to encourage further purchases, based on correlations between the customer's past selections or purchases and those of other customers who purchased from a similar or overlapping set of products. In yet other instances, a customer's profile data may be constructed from monitoring the customer's past or present activities. For example, a customer who purchased a computer is assumed to be interested in and the purchase of computers in the future. These kinds of assumptions are sometimes valid, but are generally simplistic and often wrong. In our example, the customer who just bought a computer is probably not interested in buying another computer for some time and marketing solicitations, such as e-mail notices and web-based pop-up advertisements can have a negative effect on the customer's future shopping experiences. The customers are identified upon accessing the web site by logging in using some unique login identifying information, or by being recognized on the basis of a network address associated with their client computer, or some other identifying data stored thereon.

The existing systems for analyzing and formulating customer behavior are generally database-driven lookup or simple rule-based systems. Several serious drawbacks and limitations are presented by currently-used personalization and one-to-one marketing schemes. In addition to those discussed above, other design and engineering problems arise when applying the currently-used concepts to large sets of customers and data. Current systems and methods lack versatility and cannot be generalized beyond their narrow application fields, e.g. retail marketing.

One particularly poor aspect of present systems at one end of the spectrum is their inflexible reliance on personal profiles associated with customers at the lowest level. That is, present systems tend to generate and maintain at least N customer profiles to service N customers at a one-to-one level, even if N is very large. The resulting large databases scale at least linearly in N when each customer is associated with a plurality of attributes or products. Large computer resources in memory, storage, and processing are expended to service the customers in this way. At the other end of the spectrum are the systems which over generalize and do not provide solutions that suit particular customers using the systems.

Furthermore, maintaining and processing transactions and queries from a large pool of customers or products is not very effective. Systems which practice one-to-one or conventional personalization methods fail to extract useful data or conclusions that may be applied to sub-groups of customers or products. Instead, these systems rely on the value of the personal data kept and collected for customers at the individual level in most cases.

There currently lacks a systematic method for solving the problems discussed above. In addition, the presently used systems for processing and analyzing marketing database information are expensive, slow, and rely on old data obtained from databases that can become “stale” with the passage of time. The latter point is especially important in the areas requiring timely decision-making, such as in fashion, entertainment, or technology marketing.

### SUMMARY

Accordingly, some embodiments of the present invention are directed to a method of determining a preferred grouping scheme, comprising: (A) modifying a first original object set to yield a first modified object set, wherein the first original object set and the first modified object set are of different cardinalities; (B) modifying a second original object set to yield a second modified object set; (C) calculating a value of a metric taken at least on the first and second modified object sets; and (D) repeating any of (A) and (B) based at least on the value of the metric.

Other embodiments are directed to a method of determining a preferred grouping scheme, comprising: (A) modifying a first original object set to yield a first modified object set, wherein the first original object set and the first modified object set are of different cardinalities; (B) modifying a second original object set to yield a second modified object set; (C) ordering the first and second modified object sets to yield respective first and second ordered modified object sets; (D) calculating a value of a metric taken at least on the first and second ordered modified object sets; and (E) repeating any of (C) and (D) based at least on the value of the metric.

Additionally, some embodiments of the present invention are directed to a method of determining a preferred grouping scheme, comprising: (A) modifying a first original object set to yield a first modified object set; (B) modifying a second original object set to yield a second modified object set; (C) calculating a value of a metric given by a non-commutative function of at least the first and second modified object sets; and (D) repeating any of (A) and (B) based at least on the value of the metric.

Yet another embodiment is directed to a method of obtaining a preferred ordering of a first and a second object set, the first and second object sets having a cross-space defining a matrix H, the method comprising: (A) choosing a first initial permutation, P1, corresponding to an ordering of the first object set; (B) solving a first linear program, max[f(P1, H, P2)]=G1, for a second permutation, P2, corresponding to an ordering of the second object set while keeping P1 fixed; (C) solving a second linear program, max[f(P1, H, P2)]=G2, for P1 while keeping P2 fixed; and (D) repeating (B) and (C) until any of G1 and G2 satisfies a predetermined.

Another embodiment is directed to a storage medium on which are coded instruction, which when executed on a data processing system cause the data processing system to: (A) modify a first original object set to yield a first modified object set, wherein the first original object set and the first modified object set have different cardinalities; (B) modify a second original object set to yield a second modified object set; (C) calculate a value of a metric taken at least on the first and second modified object sets; and (D) repeat any of (A) and (B) based at least on the value of the metric.

Still another embodiment is directed to a method of associating objects, comprising: (A) associating at least one element of a first original object set with at least one element of a second original object set; (B) modifying elements of the first original object set, producing thereby a first modified object set; (C) modifying elements of the second original object set, producing thereby a second modified object set; and (D) associating at least one element of the first modified object set with at least one element of the second modified object set.

Some embodiments are directed to a method of associating objects, comprising: (A) segmenting a first object set into a first plurality of object subsets; (B) segmenting a second object set into a second plurality of object subsets; (C) associating at least one element of the first plurality of object subsets with at least one element of the second plurality of object subsets using an association operation; and (D) checking whether the association operation is consistent.

An embodiment is also directed to a method of associating live data, collected by a data processing system, the method comprising: (A) sequentially receiving the live data in discrete packets; (B) placing the live data from (A) into at least one dynamic data set;

(C) augmenting the at least one dynamic data set with new live data as the new live data is received according to (A); (D) forming at least two categorical data sets from the elements of the at least one dynamic data set; (E) segmenting a first categorical data set into a first plurality of categorical data subsets; (F) segmenting a second categorical data set into a second plurality of categorical data subsets; and (G) associating at least one element of the first plurality of categorical data subsets with at least one element of the second plurality of categorical data subsets using an association operation.

Yet another embodiment is directed to a method for approximating a tendency distribution corresponding to raw data from a plurality of object sets, comprising: (A) preconditioning the raw data into a form suitable for association; (B) segmenting the raw data into at least two fine-level subsets; (C) performing a first association operation between the at least two fine-level subsets; (D) aggregating the fine-level subsets to coarse-level subsets corresponding to the fine-level subsets; (E) performing a second association operation between the at least two coarse-level subsets; and (F) comparing results from the first association operation and the second association operations.

Still another embodiment is directed to an information filtering system comprising: a profile subsystem for defining a space of profile data with a particular taxonomy, and for identifying users into a particular partition or category of this predefined taxonomy; a manipulatable collaboration subsystem, based on feedback of site usage and a popular decision rule, for identifying a particular suite of content data and delivery scheme to associate with each partition in the profile taxonomy; a content delivery subsystem for delivering particular content in combinations, sequences, and schemes as decided by the collaboration subsystem; and a visualization and analysis subsystem for engaging projections of the collaboration subsystem by either profile-based category or content-based scheme, including category and content indicators indicating other profiles or content that is similar to the object of analysis.

Another embodiment of the present invention addresses a method for conducting electronic commerce, comprising: (A) segmenting a customer base into a plurality of customer segments based on a set of customer attributes; (B) segmenting a product base into a plurality of product segments based on a set of product attributes; (C) matching a customer segment and a product segment based on a plurality of commercial activity events; (D) creating a matrix of customer segments and product segments containing information from joint correlation operations; and (E) providing the information in the matrix in a manner usable for making marketing decisions in an electronic commerce system.

Some embodiments are directed to a method for deriving correspondence between two interactive data sets, comprising: (A) dividing a first data set into a plurality of first data set segments; (B) dividing a second data set into a plurality of second data set segments; (C) evaluating a joint distribution matrix to determine a relevance indicator for indicating relative relevance of the first and second data set segments to one another; (D) subdividing the first and second data set segments into finer segments and performing act (C) on the finer segments; (E) aggregating the data set segments into coarser data set representations having fewer segments if the relevance indicator indicates a lack of relevance between the first and second data set segments; and (F) exiting the process when the relevance indicator meets a preset condition.

### BRIEF DESCRIPTION OF THE DRAWINGS

FIG. 1 shows a schematic illustration of a data processing system adapted for carrying out various aspects of the present invention.

FIG. 2 shows a schematic diagram of a storage apparatus adapted for holding stored instructions and data.

FIG. 3 shows an embodiment of two object sets having associations defined among them.

FIG. 4 shows another embodiment of an association using a tabular representation.

FIG. 5 shows an embodiment of an association producing pair association values (PAV) and a summation metric thereof.

FIG. 6 shows an exemplary representation of an association matrix.

FIG. 7 shows an exemplary representation of an association matrix with a traditionally-inadmissible association.

FIG. 8 shows another exemplary representation of an association matrix with a traditionally-inadmissible association.

FIG. 9 shows an illustrative example of a permutation to achieve a desired ordering.

FIG. 10 shows another illustrative example of a permutation to achieve a desired ordering.

FIG. 11 shows two exemplary and equally strong associations.

FIG. 12 shows an embodiment of a system for carrying out modifications and associations.

FIG. 13 depicts an exemplary process for associating object sets.

FIG. 14 depicts another exemplary process for associating object sets.

FIG. 15 depicts yet another exemplary process for associating object sets.

FIG. 16 shows an embodiment of a system for carrying out a method according to the present invention, including data collection.

FIG. 17 shows an embodiment of a proper association.

FIG. 18A, B show embodiments of staircase associations.

### DETAILED DESCRIPTION

In order to provide more flexible, generalized solutions to the association problems, some of which were outlined above, the inventors have recognized that traditional limited methods for association can be improved in ways that will be detailed below. An association model generation technology has been developed and implemented according to the present invention which in some embodiments allows for determining a preferred or optimum way to segment sets to achieve a useful association thereof. Several metrics have been developed for use with the present association modeling framework, the metrics indicative of the adequacy or strength of a given association between either entire sets or between elements thereof. The present invention includes in some embodiments an allowance for associating sets of various types and sizes, including sets having different sizes and a plurality of such sets defining a multi-dimensional association matrix formed by the cross-space of the sets' elements.

Sets are not narrowly defined, and may be abstract in nature, described as comprising “objects.” These are then generally termed “object sets,” which may be of any large number of types. Since an object can be in the form of properties, conventional data, material objects, objects of manufacture, currency, ideas, persons, organizations, or any manifestation of matter or knowledge or entity which may an element of a set, an object set as herein used is the most general and broadest type of set.

One aspect of object sets is that they may be comprised of elements which are themselves object sets. In some embodiments, the present application discloses and claims methods for optimally segmenting an object super set into a plurality of object subsets. The segmentation is considered to have a granularity or “resolution” which can range from the coarsest resolution of a single-element object set to the finest resolution, where a substantially limitless division of objects in the object set can be implemented. Increasing the number of elements in an object set by further subdivision and/or redistribution of its elements is referred to herein as “refinement.” Refinement increases the cardinality (or number of elements) of the object set.

Analogously, other embodiments of the present invention provide for aggregation of an object set by grouping existing elements together to form an aggregated object set having fewer elements than the original object set. The aggregated object set thus having a lower or smaller cardinality than its corresponding original object set.

The process of aggregating and/or refining elements of an original object set is herein referred to as “modification” of the original object set. Thus a “modified object set” comprises elements that correspond to the elements of an original object set through either refinement, aggregation or both. For example one original element or object, A, may be first split into two elements, A1 and A2 and then A1 may be further split into A1x and A1y in a refinement operation, while A2 can be combined with a different original element, B, in an aggregation operation. Note that in some cases a mere permutation of the original object set is accomplished or only a resorting or ordering is performed on the original object set. Additionally, some elements of an original object set may be altered while others are left unchanged. The present application uses the term “drilling” in some instances to signify moving to a more detailed finer resolution model or level of granularity, while using the term “aggregating” to signify moving up to a coarser level of granularity in the modeling.

Modifications of object sets include aggregation, refinement, or ordering of the sets. Elements of a modified object set are sometimes called segments. Discussed below are some specific aspects of various types of modifications, which are generally carried out using a modifier that can be implemented e.g. in a data processing system using software.

Aggregations of sets combine elements to produce a new set with lower cardinality. “Proper aggregation” is a partition of the set and can be represented by partition matrices, while more general aggregations are represented by special matrices called “covers.”

A “partition matrix” is a k×n, k<=n, matrix L that in some embodiments displays the following features: 1) the elements of the matrix are either zero or one, 2) every column sums to one, and 3) every row sums to at least one. This matrix represents a partition in the sense that given an n×1 vector v, with elements in one-to-one correspondence with an object set, Lv is a vector of cardinality k with elements in one-to-one correspondence with a partition of the object set. Note that the transpose of a partition matrix is also taken to be a partition matrix.

Given a set of cardinality k, if it is known to be an aggregation of another “finest grain” set of cardinality n, n>k, it can be represented as the aggregation of the finest grain set. Refinements of this set can then be represented as aggregations of the finest grain set to sets of cardinality m, k<m<=n. Representation of refinements then is exactly the same as that for aggregations, using partition matrices or covers that reference the finest grain.

Some modifications may comprise combinations of aggregation and refinement and possibly permutation. Other modifications can be constructed that are generated as sequences of aggregation or refinements. Referencing a finest grain set, these modifications become the product of multiple partition matrices or covers. Aggregation and refinement may be executed in software running on a data processing system as a single module or as separate aggregator and refiner elements or systems or computer code routines, all of which are modifiers.

Permutations yield an ordered set even if starting from an ordered set before permutation, and are represented effectively by permutation matrices. Permutation operations may be implemented for example by a permuter built as a machine or as software running on a data processing system. A permuter is thus one type of modifier. The present application is in some part directed to the relationships or associations between two object sets, but this is meant to be for the purpose of explanation only, and the general concepts provided herein are meant to extend to multiple object sets. That is, by teaching or claiming a concept applied to two sets it is understood that those two sets can be merely two of a plurality of three or more sets to whom the concept applies. Hence, any discussion of a matrix is intended to be extensible to multi-dimensional constructs such as cubes, hyper-cubes, etc. This idea will be understood by those skilled in the art and a detailed explanation of which is not provided herein. Suffice to say that a cross-space may be defined by two or more sets, and in the case of two object sets the cross-space of their elements forms a matrix space having elements formed by the pairs of elements of the individual object sets. The object sets can be presented in an ordering scheme or permutation of their elements that fixes the cross-space matrix. If we consider the cross-space matrix as corresponding to an association of one object set with the other, then the matrix is an association matrix H.

H may be constructed from data in many different ways. For example H can be defined using corresponding categorical data. Given a data set (I, C, V) where each V(i, j) is categorical, one may construct a frequency table defined as follows. Each column of the frequency table represents an element from a subset of the union of V(i, j) over sets I1 and C1 of interest. Each row represents an element from a subset of the union of V(i, j) over another set 12 and C2 of interest, in particular where I1=I2 but C2˜=C1. Entries (k, m) in the frequency matrix then are taken as counts of the number of instances from the categorical data table where V(i, j1)=m for (i, j1) in (I1, C1) and V(i, j2)=k for (i, j2) in (I2, C2). The resulting table can be represented as a matrix H with possibly missing entries.

H may also be defined using corresponding ordinal data or numerical data: ordinal or numerical data may be transformed into categorical by the application of a piecewise constant function. An H matrix may then be defined as above.

Populating the matrix H is the subject of several aspects of the present invention, as well as analysis of the matrix H and metrics performed on the matrix to extract useful information regarding for example the association of the object sets. In general, but not by way of limitation, the matrix H is populated with values hᵢⱼ that correspond to the individual pair-level associations of the elements of the object sets corresponding to matrix location (i, j). The entries in the matrix H may be pair association values, described earlier, except that they may be of a generalized form or of a derivation such as those which will be given elsewhere in this application. The collection of values populating H may be thought of as a distribution, which can be a frequency distribution for example. Again, the concept illustrated, supra, may be extended to multiple object sets in mutual relation that provide a multi-dimensional cross space populated with data represented by triplets, multiplets, etc., rather than pairs.

As described elsewhere in this document, H may represent a distribution or a partial distribution. One class of problems arises when H represents a joint distribution over the object sets, or data sampled from such a distribution. A partial distribution is one with missing values, and important classes of problems over partial distributions arise from considering, for example, either missing data or constraints on disallowed combinations. Problems arising from H representing an underlying distribution admit important statistical interpretations, wherein normalization of the distribution may be important for proper interpretations.

H may also represent a score matrix. There are cases when H may not represent a distribution but still characterizes a propensity or some other score between object sets. Again, missing values for unknown, disallowed, or unavailable combinations may be flagged appropriately.

Additionally, H may represent an array of dimension larger than 2: for problems defined over n object sets, n>2, one may think of H as an n-dimensional array.

A “generalized” match or association between n object sets can be represented by a table with n columns. Each row of the table is an element of the association, and the (i, j)th entry of the table describe which objects of object set j are contained in the ith element of the association. Whereas a proper association is one-to-one and onto and requires constraints on the entries of the table to be satisfied as indicated above, a generalized association has at least one element, and each element i contains at least one entry j with at least one object from the corresponding object set. Thus, a generalized association is not constrained to be either one-to-one nor onto between any pair of object sets associated, although proper associations over the power sets of all relevant object sets may capture generalized associations.

Data can be in any of a number of forms and types, and may include hybrid data types as well. For example, data may be numerical, statistical, symbolic, ordinal, or categorical. Data may be organized and represented in a variety of ways. For example, data may be analog or digital data and may be collected using empirical methods or may be generated using models or theoretical constructs or may be extracted from simulations using such models and constructs. Data may be represented and stored in a variety of ways according to its nature and the application at hand. For example, digital data may be represented as binary digits (bits) in a suitable storage medium, such as on computer disks, tapes, volatile or nonvolatile media, etc. Data may be displayed again according to its nature and use. For example, data may be represented for presentation to human users as tables, charts, graphs, sounds, colors, and can further comprise small or large groupings such as pairs, triplets, multiplets, or sets and subsets arranged in arrays, matrices, hypermatrices, etc.

Data, or a data table, can be represented in some embodiments as a triple (I, C, V) of instances I, characteristics C, and values V, where V(i, j) is a set of values that may depend on instance i from the set I, and characteristic j from the set J. A data set according to this representation is a set of data tables.

Data can also be characterized in some embodiments by the types of sets V values are chosen from. For a given instance i and characteristic j, datum (i, j, V(i, j)) is called categorical if V(i, j) takes values representing an unordered set, ordinal if it takes values representing an ordered set, and numerical if it takes values representing an uncountable set.

Object sets may comprise categorical data sets. The term “categorical data set” (CDS) is used herein to refer to an object set whose elements share a common feature or attribute, which can be used to categorize the data. Two CDSs can be associated with one another as discussed earlier. This will be clarified by way of a simple example. An object set X of workers (x₁, x₂, . . . , xₙ) may be matched with a corresponding object set Y of tasks (y₁, y₂, . . . , yₙ) needing to be accomplished by the workers. One may ask how can the workers and tasks be optimally matched or associated? One way is by an exhaustive trial and error approach, whereby every worker and task is matched in turn and the best overall result is measured. Often, this is not the best approach to obtain associations in general. It is difficult to optimally match the two sets X and Y without a sound matching scheme or association model. The problem becomes more complicated when the number of elements (e.g., workers, tasks) in each set is large. By “association model” it is generally meant a systematic procedure or algorithm for achieving a good or a best association outcome. Several models currently exists describing methods for optimal association of two categorical data sets, as discussed in the Background section.

Many “metrics” or bases for measurement, sometimes colloquially referred to as yard-sticks, may be used to evaluate the strength or adequacy of an association or other operation. When a particular metric is used for evaluation it is normally used to derive quantitative values therefrom. Suppose that a quantitative measure of the fit, strength or adequacy of an assignment is made between two elements, xᵢ and yⱼ, of a respective two object sets, X and Y, the result of the measure referred to herein as the “pair association value” for the pair (xᵢ , yⱼ), and is denoted by hᵢⱼ, which is an element of the association matrix H. The pair association value hᵢⱼ can take on one of many forms suited for expressing the corresponding association. For example, hᵢⱼ can be expressed as a number. This number may be expressed in some instances as a real number having a value lying between 0 and 1. A value of 0 may indicate the poorest possible match between the two elements, while a value of 1 may indicate the best possible match. In other instances, the value of hᵢⱼ may be a number between −1 and +1, where a value of −1 may indicate the poorest possible match, and the value of +1 may indicate the best possible match, with a value of 0 being neither a very poor nor a very good match. In yet another instance, the numerical value given to hᵢⱼ may represent a percentage. Accordingly, in some embodiments, a value of 0% indicates the poorest match and a value of 100% indicates the best match. Alternatively, the value of −100% may indicate the poorest match, and a value of +100% may indicate the best match.

There is an interest in optimizing a class of metrics, f, parameterized by a matrix H. These functions map a set of n modifications, defined over an appropriate class, to the real numbers and is addressed by various embodiments of the present invention.

Of course many other representations, whether numerical, symbolic, or otherwise may be used to quantify the quality of the match embodied in hᵢⱼ. It should be clear that solving the problem of finding the best (optimum) associations is in many cases analogous to the problem of finding the worst (poorest) associations, and that the examples given above may reverse the definitions of poorest and best matches with similar outcomes.

In the example of workers and tasks it may be considered that the optimal assignment of tasks to a given worker is a process of determining which task from a set of available tasks in Y is best suited for this particular worker. The problem may be similarly viewed as a process of determining which worker from a set of available workers in X is best suited to perform a particular task. Not all associations are permitted, but under a given set of rules in use for a particular application, the set of associations which is permitted comprises “admissible” associations.

The above concepts and formulations are translated into convenient mathematical representations in some embodiments of the present invention, such as by using matrix algebra and/or set theory, which facilitate evaluating associations and optimizing an association between object sets or elements thereof.

Myriad examples of applications for this technology abound, such as job placement services, dating services, energy distribution solutions, pharmaceutical drug design, clinical trial design, transportation planning, marketing, online education services, communication infrastructures, data storage systems, military applications, etc.

Having briefly discussed how two elements from two respective object sets may be associated. We now turn our attention to the more general problem of matching two complete object sets. In this problem the two object sets are globally matched until an optimum overall association of the two object sets is obtained.

To simplify and formalize the analysis, the present inventors have recognized that the formulation of the problem in terms of vectors and matrices is of special utility. For example, an object set having n elements may be represented as a (1×n) vector or as a (n×1) vector. Furthermore, by placing two object sets, of cardinalities m and n, that are to be associated into a (m×n) matrix or table, useful operations and calculations thereon become possible.

Note that in some special cases the cardinality of both object sets being associated is the same. In this special cases, this association scheme provides a natural element-by-element or one-to-one association, whereby each element of X and Y can be associated with a corresponding single best-match element of the respective other object set. In our example case, every worker xᵢ can be assigned to a single task it performs the best, and each task yⱼ is being performed by a single worker most suitable to do that task. However, in most global association optimizations, a compromise must exist whereby the overall association between X and Y is optimized, even if individual elements of the object sets are not all strictly associated with the best-suited corresponding element of the other object set.

It is useful in some embodiments to develop measures on the modified object sets. One may characterize a modified object set, or equivalently, the modification given an original object set, using measures that quantify some property or function of interest. Such measures may be used to characterize admissible modifications. In general, such a measure may be considered as a real valued function, f(L, H2, R), indexed by a matrix H2. The following illustrates this idea by way of a few illustrative examples:

Balancing of an association: Given a set of modified object sets and an association between them, it is possible to examine the relative impact of each element of the association towards the value of a cost function. A measure may thus be constructed, for example using a “gini index,” that characterizes the uniformity, or balancing, of impact across all elements of the association.

Balancing of marginal distributions: Given a set of modified object sets, it is possible to characterize the relative uniformity of various marginal distributions computed from a distribution, H.

Balancing of cardinality of segments: Given a modified object set represented as an aggregation from some finest level object set, it is possible to explore the relative uniformity of the cardinality of each element of the modified object set.

Homogeneity of segments: Given a modified object set represented as an aggregation from some finest level object set, it is possible to characterize the homogeneity of each segment with respect to some measure, and then characterize the overall homogeneity of the modified object set with another measure. In this case the function f indexed by H2 decomposes into an f1, characterizing the homogeneity of each segment, and f2, characterizing the overall homogeneity of the modified object set. Moreover, the matrix H2 corresponds to the characteristic defining the sense of homogeneity of interest.

Consider next the existence of a distribution referred to herein as a “tendency distribution” or “tendency curve.” This distribution represents the natural propensity of one set of objects to be associated with another set of objects. Examples are now used to reduce the level of abstraction in the discussion for the sake of clarity. However, these examples are not meant to be limiting, and the reader skilled in the art will understand how to extend the examples and discussion to other areas covered by the instant invention but not explicitly recited in the discussion or examples.

A group of consumers having some attributes and placed in a first object set, for example in a categorical data set, can be optimally matched to a corresponding group of available products, having some attributes and placed in a second categorical data set, by associating the first and second categorical data sets. The real and natural tendency of the consumers and products to associate in a particular way results in the tendency distribution. That is, there is a distribution which would represent the ideal, even if unknown, tendency of each consumer or subset thereof, to purchase or be associated with, certain corresponding products on the market or subsets thereof. This tendency distribution is of great importance, as it can provide valuable marketing information to producers of goods and services.

One aspect of the tendency curve or distribution is that it exists whether or not it is measured or known. There is a natural propensity leading to the ideal match that would become evident given sufficient data and measurement capabilities. The fact that the tendency curve is unknown, or only known with finite certainty, does not always or significantly detract from its value. After all, consumers are normally constrained by their circumstances and the markets available to them, and will still select from the available product choices, even if better choices could be made available to them in a hypothetical ideal market. Thus, a producer of goods or services might desire to investigate the tendency distribution, or to approximate it, for the purpose of delivering products and services which better satisfy the available consumer pool.

Conversely, if the vendor of goods has a fixed menu of products available to sell, the vendor may wish to investigate which demographic segments to target for advertising or marketing of the products. In other words, it may be more feasible or profitable to alter or tailor the pool or buyers than to alter or tailor the pool of products presented to the buyers.

The present inventors have recognized that a feedback exists between the market and the market model. This inter-dependence of data and data model has been incorporated into the overall modeling framework of the present invention. As an illustration, both the market and its choices have an impact on the purchasing behavior of the consumers and the purchasing behavior of the consumers influences the development and shape of the marketplace. So not only does the purchase behavior of a consumer segment influence sales figures for a product segment but results of marketing studies using the sales data will then be used to generate advertising and targeting campaigns that will in turn influence the sales data, and so on.

One aspect of the present invention is the approximation of the tendency distribution or curve by another distribution or curve. This approximation may be useful if the actual or ideal tendency distribution cannot be found or measured. Thus an efficient means for discovery or approximation of the tendency distribution is desired, and ways of achieving this approximation are provided herein according to various embodiments of the invention.

Accordingly, by judicious selection of subsets of data, or objects generally, and then by associating the resulting data or object sets, an acceptable representation of a match, which may correspond to the ideal tendency distribution, may be obtained.

Attention is directed next to an aspect of the present invention which can provide in some embodiments a more efficient method for analyzing associations and obtaining optimizations thereof. Rather than restricting the analysis to the traditional one-to-one databases at the finest level of resolution, the invention disclosed herein allows for a flexible multi-resolution analysis. Accordingly, it is disclosed that some embodiments call for examination of aggregated object sets or refined object sets, collectively “modified object sets.” This aspect of the invention permits a top-down analysis as well as a bottom-up analysis. Associations are thus performed at any level of resolution by aggregating and/or refining the original object sets. The process can be repeated iteratively. In some embodiments, the object sets are iteratively modified by refining and aggregation of the elements thereof until an optimum representation of the constituent data and association thereof is obtained. Specifically, metrics indicative of the strength or adequacy of a match between two object sets are generated at each level of resolution selected for analysis and, based on the value of the metric, it is determined whether to drill down to finer resolution in all or some elements of an object set and repeat the metric measurement, or whether to aggregate more than one element into a single aggregated element in the modified object set. When an acceptable representation of the object sets has been achieved, say obtaining an optimum resolution and permutation of the elements, and when the proper or optimum association with another similarly-modified object set has been performed, the method and system of the present invention return a model or solution to the user.

The present invention involves associations at multiple resolution, and incorporates this concept into many embodiments thereof. Solving a problem, as described elsewhere in this document, over n object sets sometimes involves constructing a set of modifications that characterize a preferred collection of modified sets and a preferred association between them. The n×1 cardinality vector, with entries given by the cardinality of a corresponding modified object set, characterizes the resolution of the problem and it's resulting solution. Often one may want to repeat the problem for different resolutions to compare parsimony or other characteristics of interest. Solving a problem over various resolutions leads to the concept of a multiresolution association. The concepts discussed below for the bipartite case have been extended by the inventors to the non-bipartite case with appropriate definitions.

It is also possible to use a “nesting” formulation along with the concept of multiresolution association. To illustrate, consider two object sets, OS1 and OS2, both with cardinality n, and index H, suppose an optimal association for resolution k1<n was found and is characterized by aggregations (L1, R1). Call the resulting optimally modified object sets M1OS1 and M1OS2, respectively. Now, suppose an optimal association is found for resolution k2<k1<n, characterized by (L2, R2), and yielding optimal modified object sets M2OS1 and M2OS2. We say the results for resolutions (k1, k2) are nested if M2OS1 is a proper aggregation of M1OS1, and if M2OS2 is a proper aggregation of M1OS2. From this definition notions of partial nesting, multidimensional nesting, or various relaxations of nesting can be defined in different ways.

The nesting property can comprise one aspect or characteristic of multiresolution associations. Nesting can define a topology over the object sets. For example, consider an original object set that is partitioned into an original objects set 1, OS1, and an original object set 2, OS2, each of cardinality n. Suppose an optimal association is found for every resolution k, k<n, and it is discovered that they are nested. Then a tree may be constructed over the element of OS1 defining which elements were aggregated at each resolution (likewise for OS2). These trees induce a topology on these sets. Moreover, various metrics between elements may be defined from these topologies, possibly also considering the value of the cost function at the corresponding resolution or other properties of the association. Given a multiresolution assignment, it is also possible to include measures that define a “best” assignment, various aspects of which have been discussed elsewhere in this document. For example, an optimal value of a cost function at each resolution characterize the assignability function for a given problem. Other measures may be likewise defined, such as any of those mentioned as measures of modified object sets. These measures capture a perspective of the problem's dependence on resolution.

Further formulation of some aspects of the invention is presented next. First the concept of representations of overlapping segments is described: For some L of size k×n represent an aggregation matrix, then the product segments are aggregates of the finest scale segments having at least some of the following properties (independent of the association):

1. the segments are non-empty if and only if L1>1

2. the segments are mutually exclusive (ME) if and only if 1A<1

3. the segments are collectively exhaustive (CE) if and only if 1A, 1y>1

4. each object can appear in at most r segments if and only if A1<r.

Next, we present a class of functions f motivated by (but not restricted to) computing different statistics of the resulting modified set. Consider the (ij) block of the matrices L Th R given by Hi, j=[1] Hn, m [rj ], and consider a collection of functions qᵢⱼ on the (i, j) blocks. If P is a function on R^{m, then}

f(L, R, H)=

represent a function on the modified set of objects which is the composition of aggregation functions and overall cost.

Several classes of aggregation measures are used. These functions can in general be nonlinear. An example of such a function is P(A)=maxij aᵢⱼ.

Some functions are linear in Hᵢⱼ. Examples of this class are:

qᵢⱼ(A)=Yᵢⱼa.

$${q}_{i , j} ( A ) = \frac{1}{n} {\sum }_{i , j} {a}_{ij}$$

where n is the number of rows.

Other functions linear in either L or R. The second example above is not linear in L. Additionally, several classes of cost functions are also used. These include functions that can be linear or nonlinear in their arguments. Examples of these functions arising from this decomposition include the following:

Case 1. This arises when qᵢⱼ (A)=q(A)=Yᵢⱼa and P(A)=trace(A). The resulting function is given by:

trace (LₖH Rₖ)

Nonlinear cost functions may be considered and may be composed using the above aggregation function q. For example P(A)=fₗᵢaᵢᵢ. The resulting function is given by:

$${\prod }_{i} {( {L}_{k } H {R}_{k}^{′} )}_{ii}$$

Another example is P(A)=mini aᵢᵢ. The resulting function is given by:

$${min}_{i} {( {L}_{k} H {R}_{k}^{′} )}_{ii}$$

Case 2. One generalization simply scales substantially every element of Lₖ H R′ₖ by a weight. This can be represented by an element-wise multiplication of a full matrix W to yield Lₖ H R′ₖ ⊙W. Alternatively, one can stack the k×k matrix Lₖ H R′ₖ into a k²×1 vector vec (Lₖ H R′ₖ) and multiply it by the k²×k² diagonal matrix of the vector stack of W, diag{vec(W)}. This is referred to herein as the “weighted trace formulation”

trace (Lₖ H R′ₖ⊙W)

Case 3. There exists a more general linear functions than the trace. Taking Lₖ H Rₖ (or Lₖ H Rₖ ⊙W), instead of maximizing the trace of this k×k matrix, one can stack it into a k2×1 vector, v=vec (Lₖ H R′ₖ). Then the function c′v is a linear cost function for any c=[c₁c₂. . . cₖ₂]′. The resulting function can be written as:

c′vec(Lₖ H R′ₖ ⊙W)

Case 4. An average aggregation function can be parameterized to include a simple sum aggregation as a special case. Consider a diagonal k×k matrix G_{L} given by:

$${G}_{L} = [ \begin{matrix}\frac{1}{g1} & 0 & ⋯ & 0 \\ 0 & \frac{1}{g2} & ⋯ & 0 \\ ⋮ & ⋮ & ⋰ & ⋮ \\ 0 & 0 & ⋯ & \frac{1}{gk}\end{matrix} ]$$

where

$${g}_{i} = \{ \frac{{χ}_{i}}{1} \frac{if {\sum }_{j} {1}_{ij} \geq 1}{otherwise}$$

Depending on the value of _{X}, different aggregation functions can be realized by multiplying G_{L}Lₖ (analogous definitions can be made for G_{R}). For example, the simple sum aggregation is realized by _{Xi}=1∀i, while the average aggregation function takes _{Xi}=Σⱼlᵢⱼ. f is then given by

trace(G_{L} LₖH R′ₖG′_{R})

Depending on the value of _{X}, different aggregation functions can be realized by multiplying G_{L}Lₖ (analogous definitions can be made for G_{R}). For example, the simple sum aggregation is realized by _{Xi}=1∀i, while the average aggregation function takes _{Xi}=Σⱼlᵢⱼ. f is then given by

trace(G_{L} Lₖ H R′ₖ G′_{R})

The general association problem at a resolution k can be defined as follows:

$${max}_{{L}_{k} , {R}_{k}} {f}_{1} ( {L}_{k} , {R}_{k} , H1 )$$

subject to

aᵢƒᵢ(Lₖ, Rₖ, Hi)\overline{a}ᵢ, i=2, 3, . . . s

ƒ₁ represent the metric of interest, and ƒᵢ, i≧represent the various constraints imposed on the modifications either through aggregation constraints or through additional measures of interest. The present application considers (but not exclusively) in the cases where ƒᵢ's are linear functions in Lₖ for fixed Rₖ and the reverse.

Examples of problems addressed thereby include:

max_{L}_{ₖ}_{, R}_{ₖ} trace(Lₖ H R′ₖ), Lₖ and Rₖ are standard aggregations. The trace function coincides with obtaining a one-to-one association between aggregate objects.

max_{L}_{ₖ}_{, R}_{ₖ} πₗ (Lₖ H R′ₖ)ᵢᵢ, Lₖ and Rₖ are standard aggregations.

max_{L}_{ₖ}_{, R}_{ₖ} minᵢ (Lₖ H R′ₖ)ᵢᵢ, Lₖ and Rₖ are standard aggregations.

max_{L}_{ₖ}_{, R}_{ₖ} trace (Lₖ H R′ₖ) subject to Σⱼ (LₖH)ᵢⱼ≦bᵢ, Lₖ and Rₖ are standard aggregations.

Balancing the marginal distribution with respect to another measure.

Balancing the number of finest level segments. If L is the aggregation matrix, then this corresponds to Σⱼlᵢⱼ≧gᵢ. Σᵢgᵢ≦n.

max c′vec(Lₖ H Rₖ^{′} [symbol] W), Lₖ and Rₖ are standard aggregations. This is a general linear cost function and constitutes a generalization of the trace function. As an example, c can represent summing both diagonal and upper diagonal elements of the argument.

max trace (G_{l L}ₖ H Rₖ^{′}G_{R}^{′}), Lₖ and Rₖ are standard aggregations. This cost is referred to herein as “fair-per-capita” cost function and it is generally not linear in Lₖ nor Rₖ.

In the case of one sided aggregation with cost trace (G_{L}LₖH), we can re-parameterize the problem observing that:

$${max}_{{L}_{k}} trace ( {G}_{L} {L}_{k} H ) = {max}_{G} {max}_{{L}_{k} ∈ {A}_{G}} trace ( {L}_{k} H {G}_{L} )$$

where A_{G} is the set of all L such that ΣⱼLᵢⱼ=gᵢ, gᵢ are non-zero integers and Σgᵢ=n. The problem

$${max}_{{L}_{k} ∈ {A}_{G}} trace ( {L}_{k} H {G}_{L} )$$

is a linear program.

Another contingency that can arise is that the distribution may be only partially defined over the domain P₁×P₂× . . . ×Pₙ implied by a partition P. For example, in the bipartite case, the distribution H may not take values for every element of its matrix:

$$H = [ \begin{matrix}{h}_{11} & {h}_{12} & & \\ {h}_{21} & {h}_{22} & {h}_{23} & {h}_{24} \\ & & {h}_{33} & {h}_{34} \\ {h}_{41} & & {h}_{43} & \end{matrix} ]$$

Given a partial distribution, it is useful to understand what the meaning of the missing elements should be.

One possibility is that the missing elements may represent hard constraints disallowing the corresponding association. Associations may not be made, then, between aggregations that include the disallowed elements. To accommodate this contingency, we define a distribution Ξ from the partial H as follows:

$$Ξ = [ \begin{matrix}\frac{1}{{h}_{11}} & \frac{1}{{h}_{12}} & ∞ & ∞ \\ \frac{1}{{h}_{21}} & \frac{1}{{h}_{22}} & \frac{1}{{h}_{23}} & \frac{1}{{h}_{24}} \\ ∞ & ∞ & \frac{1}{{h}_{33}} & \frac{1}{{h}_{34}} \\ \frac{1}{{h}_{41}} & ∞ & \frac{1}{{h}_{43}} & ∞\end{matrix} ]$$

and consider the minimization problem

$$ξ ( k ) = {min}_{{L}_{k} , {R}_{k}} trace ( {L}_{k} Ξ {R}_{k} ) .$$

This problem will avoid aggregating the disallowed elements whenever possible. Considering 1/∞=0, the assignability function produced by plotting 1/ξ (vs. resolution level k) reveals the performance of optimal allowed aggregations while flagging disallowed aggregations with a value of (exactly) zero. This assignability function will be zero for at least one resolution, indicating that admissible solutions to the problem do not exist at those “zero levels.” In fact, it is possible that the constraints present an admissible solution at every level.

Another way of addressing avoidance constraints is to use assign the value −1 to the (i, j) terms that are not to be aggregated. We then follow the standard formulation which will prevent aggregations and matching of undesirable segments.

Another possibility is that H represents partial information of a full distribution, and that the missing elements simply indicate where values of the distribution are uncertain. In this situation aggregations over missing elements are allowed, but the quality of a match between aggregations containing uncertain elements may be dubious. In this situation, a lowerbound to the expected performance of a match can be obtained by considering the missing values as variables

$$H ( x ) = [ \begin{matrix}{h}_{11} & {h}_{12} & {x}_{1} & {x}_{2} \\ {h}_{21} & {h}_{22} & {h}_{23} & {h}_{24} \\ {x}_{3} & {x}_{4} & {h}_{33} & {h}_{34} \\ {h}_{41} & {x}_{5} & {h}_{43} & {x}_{6}\end{matrix} ]$$

and solving:

$${min }_{{x}_{1 ,} … {x}_{6}} {max}_{{L}_{k} , {R}_{k}} t r a c e ( {L}_{k} Y {R}_{k} ) .$$

where x1, . . . x6≧0. One solution to this minimization is at x1, . . . , x6=0, thus we can consider defining a distribution Υ from the partial distribution H as follows:

$$Y = [ \begin{matrix}{h}_{11} & {h}_{12} & 0 & 0 \\ {h}_{21} & {h}_{22} & {h}_{23} & {h}_{24} \\ 0 & 0 & {h}_{33} & {h}_{34} \\ {h}_{41} & 0 & {h}_{43} & 0\end{matrix} ]$$

and then solve the usual multiresolution matching problem:

$$v ( k ) = {max}_{{L}_{k} , {R}_{k}} trace ( {L}_{k} Y {R}_{k} ) .$$

Here, the assignability function v is a lower bound to the usual assignability function γ that could be achieved without uncertainty.

Another situation where partial information may play an important role is where the partial distribution H is defined over a partition P of a subset of the universal set, V⊂U. Here one would like to use information from V′ to estimate the missing values in H.

LR iteration is a process of iteratively the cost function by solving linear programming problems. LR is applicable when ƒᵢ's in the formulation section are linear in Lₖ with fixed Rₖ and linear in Rₖ with fixed Lₖ.

The discussion below illustrates how to perform the iteration according to some embodiments of the present invention:

A. first describe how LR is performed for the standard max trace problem.

1. Initialize L⁰.

2. For L¹, compute

$${R}^{j + 1} = a r g {max}_{{R}_{k}} t r a c e ( {L}^{j} H {R}_{k}^{′} )$$

3. For R^{j+1}, compute

$${L}^{j + 1} = a r g {max}_{{L}_{k}} t r a c e ( {L}_{k} H {R}^{j + 1} )$$

4. Set j=j+1.

5. Repeat until a criterion is met.

This introduces a sequence of solutions with increasing cost. The algorithm is guaranteed to converge to a local maximum. By randomizing L⁰, we converge guarantee convergence to the optimal in a weak probabilistic sense. Each problem in the algorithm is a linear program whose solution is guaranteed to be integer-valued.

B. We describe how LR is performed for general linear functions:

1. Initialize L⁰.

2. for L^{j}, compute

$$R {c}^{j + 1} = a r g {max}_{{R}_{k}} {F}_{1} ( {L}^{j} H {R}_{k}^{′} ) ,$$

subject to aᵢ, i=2, 3, . . . s

3. Approximate Rc^{j+1} with an integer valued matrix by solving:

$${R}^{j + 1} = a r g {max}_{{R}_{k}} t r a c e ( R {c}^{j + 1} {R}_{k}^{1} )$$

4. for R^{j+1}, compute

$${Lc}^{j + 1} = arg {max}_{{L}_{k}} trace ( {L}_{k} H {R}^{j + 1} )$$

5. Approximate Lc^{j+1} with an integer valued matrix by solving:

$${L}^{j + 1} = a r g {max}_{{L}_{k}} t r a c e ( {L}_{k} L {c}^{j + 1 ,} )$$

6. set j=j+1.

7. Repeat until a criterion is met.

iii. L-R-G iteration

Let g be a k-dimensional vector such that Σgₗ,=n, gᵢ≧1. L is a kxn g-aggregation matrix if

$$\begin{matrix}{\sum }_{j = 1}^{n} {l}_{ij} = {g}_{i} & i = 1 , … k \\ {\sum }_{i = 1}^{n} {l}_{ij} = 1 & j = 1 , … , n\end{matrix}$$

Denote this set of matrices by gA.

Example problem 1:

The following problem can be approached by LR iteration as discussed above.

$$μ ( g ) = {max}_{L , R} f ( L H {R}^{′} ) s u b j e c t t o L ∈ g A , {R}^{′} ∈ A .$$

Example problem 2:

$$μ = {max}_{L ∈ A , R ∈ A} f ( {LHR}^{′} ) subject to = {max}_{g} μ ( g )$$

where Σgᵢ=n, gᵢ≧1.

This equivalence suggests that Problem 2 can be solved by picking a strategy on g (say randomize) and solving an LR iteration. Other than randomization, g can be selected to improve balancing of different segments.

Also, as discussed before

$${max}_{{L}_{k}} trace ( {G}_{L} {L}_{k} H ) = {max}_{G} {max}_{{L}_{k} ∈ gA} trace ( {L}_{k} HG )$$

where gA is the set of all L. The problem max_{L}_{ₖ}_{εgA} trace (LₖHG_{L}) is a linear program. The search over Lₖ is now replaced by a search over a vector g. This approach converted the nonlinear problem by a search over linear problems.

Various aspects of the present invention allow for an automated, e.g. computerized, control of the drilling based on rules. This allows for inclusion of machine learning models to further enhance the invention by using expert systems or others to facilitate efficient determination of preferred segmentations and representations of modified object sets that yield useful approximations of tendency curves and other benefits.

In addition to machine-driven analysis, a human “pilot” or operator can be used to direct the process. The pilot may be someone skilled in the art of association or marketing or another art relevant to the application at hand. The pilot may use his or her skills and prior experience for example to decide where to start the drilling and analysis process or to decide on initial compositions of the associated object sets. The pilot can determine also when a sufficient criterion for optimum association has been reached and decide to end the process and report the results.

Below, a general description and some embodiments of a top-down process for computing model-based associations is described. “Top-down” typically implies that a cardinality of the feature set describing all object sets remains constant or increases with each iteration of the process. According to some aspects of the top-down process, computational complexity is reduced and it allows for the development of parsimonious models with small amounts of data. The process may be broken down into 3 general phases: data collection, model building, and association implementation and tracking. Note that some of the sets within each phase of the process are optional and may depend on the application.

First, data is collected and formatted such that at least 2 distinct object sets are well defined and represented by a set of features. The formatting process may consist of extracting data from legacy systems or data warehouses into structured tables that easily render the construction of the data matrix H. A human pilot then specifies her objectives in executing the associations, and any constraints she may have on the associations. For example, the pilot may wish to restrict the number of associations to be generated due to high cost of executing each association. Or, the pilot may wish to restrict associating particular objects with other objects.

Given the pilot's inputs, the automated part of the process, herein referred to as the “system”, then constructs the data matrix H, and computes a multi-resolution association model, which comprises the optimal modified sets, their representations, and their associations for resolutions 1 to the smallest cardinality of the original object sets. The system then selects one resolution model based on some criteria, which may include pilot-induced constraints, or previously defined notions of consistency, balance, and homogeneity, or other measures on the modified object sets or associations. This selected model is herein referred to as the “single association model (SAM)”.

Before displaying the SAM to the pilot, the representations of its modified object sets are simplified to generate what is herein referred to as their “minimal descriptions”. To construct the minimal descriptions, the system selects a set of “relevant” features (a subset of the feature set that represents the two original object sets) that best describe the modified objects within the SAM. A feature of the original set is determined to belong to the relevant set based on a criterion that measures how necessary the representations of the modified sets require that particular feature. The new representations of the modified object sets spanned by the set of relevant features may be equivalent to or an approximation to their original representations.

The structure of the SAM also renders suggestions on where and how to drill within the SAM. Determining where to drill requires determining which segments lacks homogeneity. It is desirable to drill within an element of the modified object set, a segment, that is not very homogeneous. Determining how to drill within a non-homogeneous segment requires analysis on pair association values involving that segment, that are significant but not in its association. These drilling suggestions are interpreted by the pilot, who determines what new features to use to improve the SAM.

The pilot or the system constructs focus and control groups within each element of the modified object sets, for which she will execute the association as determined by the SAM. Note that since the modified sets are constructed from the original sets by aggregation, each element of a modified set consists of one or more element from the original object set (or one or more “finest grain element”). The focus and control groups created for each element of the modified object sets thus each comprise a representative subset of the finest grain elements.

The results are then tracked by the system and used to determine how to modify the size of the focus groups. For example, executed associations on focus groups that contribute positively towards the pilot's objectives will be positively reinforced, whereas executed associations that contribute negatively will be de-emphasized. For example, one aspect of evolving the focus groups as described above is to start off with each having the same cardinality. Then, when a focus group is determined to contribute positively, the system or pilot increases the cardinality of that group. When a focus group is determined to contribute negatively, the system or pilot decreases the cardinality of that group.

While associations are being executed, the new features injected by the pilot may be incorporated and the process above may iterate to improve the pilot's objectives. It should be understood that the pilot is not limited to only the human pilot described, supra, but may also be a machine that substantially acts in a way similar to that described for the human pilot. Expert systems or intelligent agents may thus be used as pilots in the present invention and the term “pilot” is intended to encompass any such agents or machines.

There exist numerous marketing applications enabled by a SAM, defined earlier. These following is a brief list of exemplary application, not intended by way of limitation, and only directed to one field, that of commercial promotion design, to illustrate some of the concepts presented by the instant application:

1. Targeting/Personalization

2. Policy/Promotion design

3. Policy/Promotion response analysis (sensitivity analysis)

4. Design of new products and or product bundles

5. Design of new product hierarchies

According to some embodiments of the present invention, two classes of SAMs can be used to describe and enable the exemplary applications. Both classes take into account a business's data set and partitions the set into two, one being a customer data set and the other being a product data set. The partition of the data set is thus in some but not necessarily all cases restricted to be bipartite. The modified object sets resulting in the SAMs are: the set of customer segments and the set of product segments. Note that elements of a product segment may be either individual products or distinct bundles of products. One feature of the two classes of SAMs is the cost function over which they are optimized. The two cost functions over which the SAMs are aligned with the associations comprise a proper association and a staircase association.

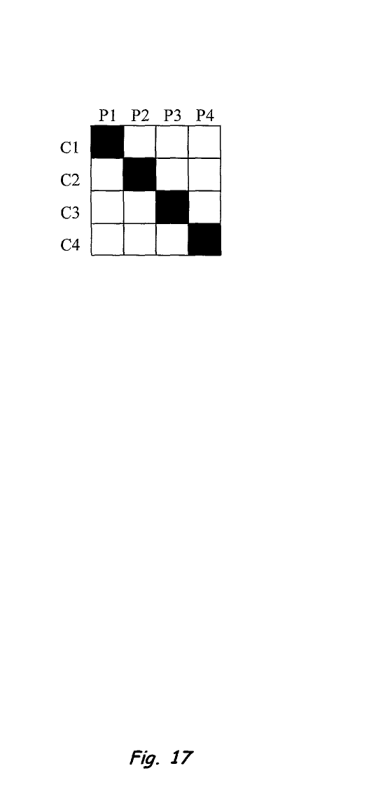

In a “proper association” the cost function is the trace of the data matrix LHR, and the diagonal elements of LHR consist of the associations, as shown in FIG. 17, which illustrates an example of a proper SAM consisting of 4 customer segments (C1-C4) and 4 product segments (P1-P4), where Ci is associated to Pi for i=1, 2, 3, and 4.

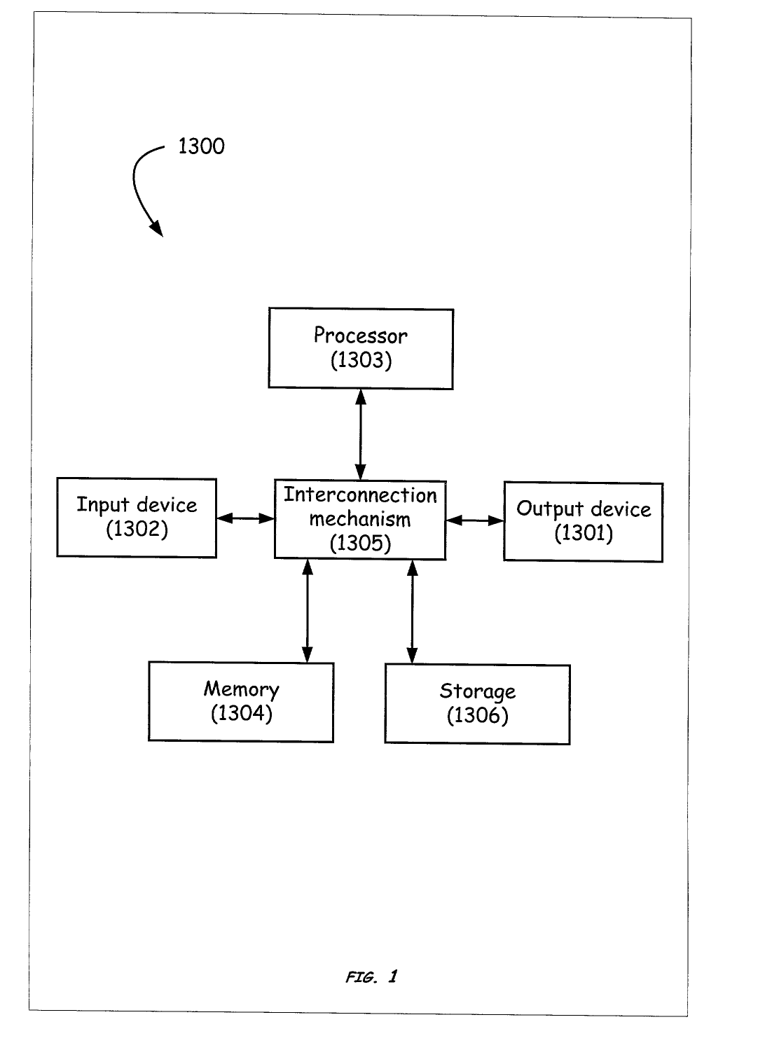

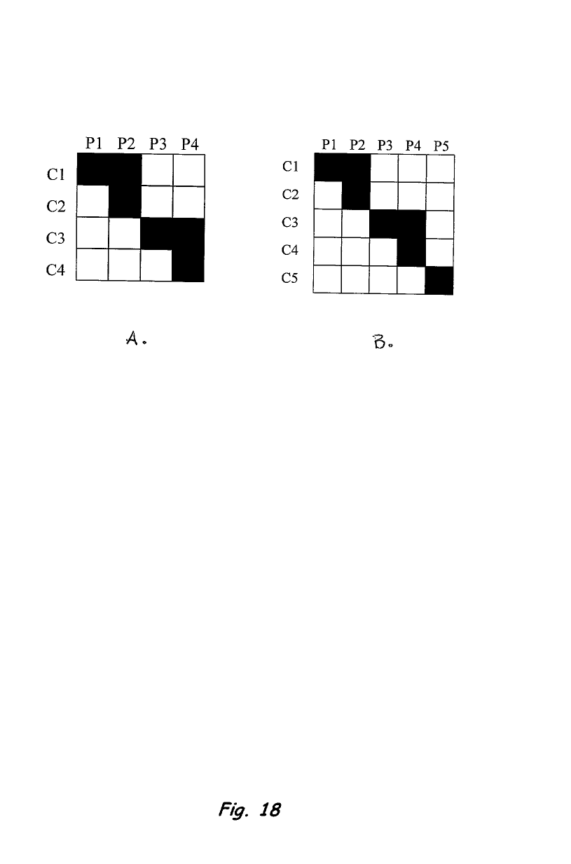

In a “staircase association, ” the cost function is the sum of the staircase elements of LHR, as shown in FIG. 18. Similarly, the associations consist of the staircase elements of LHR. Thus, for the casein which the cardinalities of the modified object sets are even, the odd numbered customer segments are associated to two elements of the modified product set, while the even numbered segments are associated to one product segment. See FIG. 1 8A. For the case in which the cardinalities of the modified object sets are odd, the same associations hold except for the last segment (which is odd numbered) is associated to only one product segment. See FIG. 18B. In FIG. 18A below, the staircase SAM consists of 4 customer segments (C1-C4) and 4 product segments (P1-P4), where Ci is associated to Pi union P(i+1) for i=1, 3 and Ci is associated to Pi for i=2, 4. In FIG. 18B, the staircase SAM consists of 5 customer segments (C1-C5) and 5 product segments (P1-P5), where Ci is associated to Pi union P(i+1) for i=1, 3 and Ci is associated to Pi for i=2, 4, and 5.

“Targeting” or “personalization” entails customization to a customer's or customer segment's needs and preferences to increase customer satisfaction and profit. For example, if a customer is shopping on-line using a vendor's web site, she experiences personalization when the vendor's web site only shows her content of shoes that she (or the segment in which she belongs) would be interested in instead of showing her all types of shoes. An equivalent off-line example would be that a customer walks into the vendor's store and the store is automatically arranged in a manner such that everything she (or her segment) is interested in purchasing is in the front of the store or highly visible to her, while the rest of the shoes are either not displayed or less visible to her. Targeting can be sometimes considered a by-product of the proper SAM constructed as described above. The targeting rules are then simply the associations of the SAM since each element of one modified set is a customer segment and each element of the other modified set is a product group. Note that the size of a customer segment may have cardinality equal to 1 if the original object sets elements consist of individual customers. Thus, targeting is addressed by the proper SAM at both the individual and segment levels.

Policies or promotions are typically short-term offers that consist of one product or an assembly of products packaged and priced to increase profit. The designs of various types of promotions are facilitated by SAMs. These promotion types include individual-level, segment-level, isolated opportunistic, segment-collaborative, and segment arbitrage promotions.

Standard global policies typically involve pure discounts on the same set of products and are executed on all customers, whereas individual-level and segment-level promotions typically involve pure discounts on different products targeted to different individual customers or different groups of customers, respectively. Such policies may be designed from the proper SAM. The targeted segments are defined by the modified customer set of the SAM, and the discounts targeted to each segment are applicable to a subset of products in its associated product segment.

Isolated opportunistic promotions are designed to be attractive primarily to a particular segment for which the business is trying to achieve a specific change in behavior, such as lifting frequency of purchase or lifting volume per transaction. Such policies may be designed from the proper SAM constructed as described above. The targeted segments are defined by the modified customer set of the SAM, and the products that they are associated with tend to be sets of products they buy. Thus, if one observes that the purchase frequency, for example, of a segment is smaller than the average across all customers, then one may design a promotion that offers a discount coupon that may be used only on the next visit (which expires after some date) on one or more of the products in the product segment they are associated with. This gives customers in the targeted segment an incentive to return to the store soon, which may potentially lift its overall purchase frequency.

Segment collaborative policies attempt to promote a set of products to a segment that has shown no prior history of buying that set, but shares common needs with another segment that does purchase the promoted set of products. Common needs of these two segments are inferred from the existence of overlapping purchases in other products. Such policies may be designed from the staircase SAM constructed as described above. One example is to consider the case of FIG. 18A. One can view this as a 2-by-2 SAM, by interpreting the first two customer segments as one customer segment block, and the last two segments as the second customer segment block. Likewise, define the first 2 product segments as the first product segment block and the last two product segments as the second product segment block. Then, associate the first customer segment block with the first product segment block, and the second customer segment block with the second product segment block. Each customer segment block now shows a sub-group of customers that buy products from two product segments, and the rest of the block segment buying products from just one of the two product segments. For example, as shown in FIG. 18A, C1 tends to buy products from P1 and P2 while C2 tends to buy only P2. One can execute a segment collaborative policy to C1 in customer segment block 1 that only purchase products in P2, buy cross-selling products in P1 with products in P2. “Segment arbitrage” policies are structured to increase a behavioral lever with respect to a product for which the targeted segment seems to have an affinity, using knowledge that there exist other segments that show that the desired behavior is possible. Consider the staircase SAM in FIG. 18A once again, with the block segments and block associations defined in the previous paragraph. In this example, a segment arbitrage opportunity may also exists if the overlapping cell in customer segment block 1 (overlapping cell=row 1 and column 2) has a slightly lower pair association value than the non-overlapping cell assigned to the same product segment (row 2 and column 2). Such association values would imply that there may be opportunity to increase the value of associating customer segment 1 to product segment 2, since customer segment 2 has a high value to be associated with product segment 2. Thus, if the values indicated purchase frequency, then one can design a segment arbitrage promotion to C1 by cross-selling products from P1 with products in P2 with the hope of increasing the frequency (since a higher frequency of purchasing products in product segment 2 exists in customer segment 2) of P2 purchases by C1.

Once promotions of the type above are executed on focus groups within each customer segment, and responses tracked, sensitivity analysis may be performed to understand the market better. Such analysis includes measuring elasticities to price, product types, and purchase behavior such as frequency and volume.

To measure price elasticity of a particular customer segment, one can design an isolated promotion (enabled by a proper SAM) that discounts a product that the segment is associated to but that does not buy very frequently. If there is a high response of the segment to this promotion, then one may infer that the original price of the product discounted was too high for this customer segment. Varying the percentage of the discounts to different focus groups within the segment, may even indicate what the appropriate price is for the product to be sold frequently to this segment.

Similarly arbitrage promotions (enabled by a staircase SAM) may be executed to segments to determine how much segments “like” or “need” certain products. For example, if customer segment 1 of FIG. 18A received the arbitrage promotion described in the earlier example, and these customers did not respond well to the promotion, then this may indicate that regardless of how the business prices products in product segment 2, customer segment 1 simply won't purchase more from product segment 2.

Other notions of purchase behavior such as frequency and volume may also be studied. For example, if a business executed an isolated opportunistic policy like the one described in the previous example, where the targeted segment had low purchase frequency, and the segment simply did not respond well to the promotion which gives them a discount on products that they are associated with if they return to the store before some date, then the business may infer that this segment consists of customers who just do not shop at this store that often. Elasticity to purchase volume of segments may also be studied in a similar fashion with isolated opportunistic promotions designed to increase volume.

Another functionality enabled by at least some embodiments of the staircase SAM is the design of new product bundles. Both the segment arbitrage and segment collaborative promotions use the staircase SAM to design and test out new bundles (cross-sells) to customer segments.

Yet another functionality enabled by at least the proper SAM is the design of new product hierarchies. The SAM generates product segments, which may in turn be directly translated into a novel way to re-organize a business's product classification scheme. Thus, consider a business that divides their products into cars and motorcycles in hopes of designing isolated opportunistic promotions. This may not be the optimal way to group products if it is difficult to distinguish between a motorcycle buying customer and a car buying customer. However, if the proper SAM groups the products into sporty vehicles and family vehicles because two distinct customer segment purchase one or the other exclusively, then it may be to the business's advantage to rethink how they think about their product classification scheme.

Some aspects of the invention return visual data such as frequency distribution diagrams or histograms which can be analyzed according to those methods for analyzing visual data known to those skilled in the art. For example, a skilled pilot or a machine having been programmed with pattern recognition routines may be able to determine the adequacy of an emerging association by analyzing the distribution contour or slices taken therethrough. Other representations such as scatter plots and graphs can be used to evaluate the results of a drilling process according to aspects of the present invention.

Additionally, empirical and numerical experiments can be conducted to useful end by way of some other embodiments of the present invention that permit gauging “market elasticity.” These embodiments are directed to a process and system which fixes some aspect of a market, akin to “controlling” for some factor, then adjusts another factor or feature to determine useful market data therefrom. For example, a measurement of the cost benefit or return afforded by a certain modification in product line or advertising campaign can be evaluated. Also, a sensitivity analysis can be performed thereby, telling of the market sensitivity to the factor being tested.

Yet another aspect of the present invention relates to achieving “consistency” in the context of association modeling and object set design. In some embodiments, the iterative process of achieving the optimum association of object sets is evaluated for convergence. By “convergence” it is meant that a diminishing improvement is generally realized and that that diminishing improvement is correlated to an incremental approach of some quantity or entity towards its ideal or optimum state. It should be understood that local variations might occur, but that in most cases the process can converge to an optimum monotonically or substantially so. It should also be understood that depending on the starting point of the iterations, e.g. by selecting a particular object set initial resolution and composition and permutation, local optima might exist. The present invention is capable of utilizing prior known techniques such as linear programming for deriving optimizations in the process, but is not so limited and is intended to encompass the presently-discussed optimizations as well as others not specifically disclosed but known to those skilled in the art and of equivalent nature and utility.

In learning theory, consistency is equivalent to the convergence of an estimated quantity to some stationary distribution. In most cases, one can empirically only test convergence of moments of a distribution; typically including the mean. Error estimates using asymptotic theory, laws of large numbers, and “Chi-squared” distributions may be used for this purpose.

Care needs to be taken to identify precisely the quantity that is consistent. A sample path distribution that approaches a periodic distribution is clearly consistent. This follows from the fact that periodic maps are stationary on a lifted domain. A sample path distribution that does not normally converge may converge if distribution is aggregated over some fixed interval length. This is equivalent to a weaker notion of convergence, referred to as “weak convergence”. Weak convergence includes the case where samples of a sequence converge.

It should be noted that if one is interested in observing how a sequence of optimization problems is consistent, one may look at the set of all optimal solutions in the context of convergence.

Some notions of convergence that are directly connected to modeling associations are given below by way of example:

1) The case where H(t) converges: this is convergence in the strong sense; where the difference |H(t)−H_0| approaches zero as t goes to infinity, where t is time.

2) The case where LH(t)R converges: this is also a strong notion, but is defined only on the aggregate matrix.

3) The case where a function, f(LH(t)R), converges: this is a weak notion of convergence, where convergence is normally guaranteed for a class of functions f. Examples of such convergence include convergence of trace(LH(t)R), or convergence of the match values (LH(t)R).

4) Convergence of L*, R*: if $L(t), R(t)=arg max trace (LH(t) R), in which case we consider the convergence of L(t) and R(t) to some fixed matrices. Again, we can consider strong convergence or weak convergence. Strong convergence usually dictates that the modification on the object set stops. Weak convergence suggests that some minor modifications can be allowed.

One aspect of the present invention includes using “cross validation” as a way to quantify the degree of consistency of a model. Cross validation can be broken down into the following steps: (1) computing a model, and obtaining L, R; (2) validating with a new set of data using or having an allowable error criterion. In some cases this means populating the new data set using the same model and measuring an error between the past and new distributions at the aggregate level; (3) repeating the match to see if it is stable or has converged.

Problems posed over finite domains admit solutions by exhaustive search, although the computational complexity of such solutions may be impractical in some situations. Nevertheless, the nature of these problems is more formidable, in the sense that the problem formulation is, in many common situations of interest (such as the bipartite problem with linear commutative cost, such as the trace function) which are over-parameterized in order to simplify the characterization of admissible solutions. This over-parameterization means searches that can lead to redundant computation and an increase in computational effort.

Such computational effort can be minimized, however, by characterizing redundant modifications and restricting the search to a limited domain. We accomplish this by making an equivalence between modifications such that L1=P L2, where P is a permutation and L1 and L2 are both k×n, where k<n. The problem is then solved over the equivalence classes of modifications.

Methods utilizing nesting/sorting can be used in many applications as described elsewhere in this document. Some aspects of the methods and systems arising from the present invention implement algorithms, although in this framework this statement is not limiting but is made to aid in understanding the underlying logic. Considering as an illustrative example a problem of generating optimal aggregations and their associated matches for all resolutions k<n, nesting properties of a solution has been discussed elsewhere in this document. Specialized searches can be designed to yield nested solutions, and special sorting mechanisms can be employed to enable such nested solutions.

It is sometimes useful to restrict the complexity of the problem by limiting the solution class to aggregations such that the resulting aggregated sets are proper aggregations of some set of specified finer solutions. Consider, for example, the case where the solution is restricted to be a proper aggregation of the solution at the next finer level. Then the problem can be solved recursively, computing the solution at resolution k from the solution at resolution k+1, and the resulting search can be considerably smaller.

The nesting, described above can be further restricted according to a nesting heuristic under the assumption that the optimal solution is (L, R) satisfies R=L′ which operates analogously for non-bipartite problems as well.

Enabling various aggregation measure, cost functions, constraints, and multidimensional problems become more transparent since the solution can be recursive. Routines then are generated that compute the next level array index, aggregated H, using the appropriate aggregation measure, then an efficient search can be executed respecting constraints and using the cost function to compare solution candidates. When the complexity of even this search is prohibitive, it can be systematically scaled yielding controlled sub-optimal solutions. This can be important as the same need for quality may not be necessary at every level.

More general nesting routines can be implemented, where the nesting requirement is relaxed at coarser resolutions when the problem complexity reduces, thus freeing up computational resources to relax simplifying assumptions on the solution. Moreover, randomization procedures can be used to yield good solutions with high probability.

Various applications require study of matching models when H comprises data sampled from a relevant distribution. The modeling aspect of the problem arises from considering how to characterize the matching properties of an underlying distribution from which the data is sampled. When H(t) is comprised of samples from a distribution, where t indexes the sampling, the formulations mentioned elsewhere become dynamic with potentially dynamic solutions. Two cases of such sampling is when the data is collected “real time, ” meaning on the order of the cycle time from policy execution to response measurement, or when H(t) is warehoused for subsequent time series analysis. Thus, in recent years, various internet applications have considered “live” data processing where the cycle time for real-time response is short and even next-day processing is considered “batch”. In either case, however, convergence properties of these solutions as the number of samples increases become important in the analysis of the predictive quality of any model derived from such solutions.

Note that assignment modeling and consistency validation, however, do not require time series data. Since the resulting assignment model is static, other, weaker notions of consistency apply. Here we explore, in the context of other, standard notions of consistency, novel forms of consistency that are meaningful in particular for association models.

The nature of the present invention will become apparent upon reading the description of the aspects of embodiments thereof, and especially when read in conjunction with the associated figures in which like elements are denoted by like reference numerals.

In some preferred embodiments, aspects of the present invention are carried out on a data processing system or on a computer system. A computer system 1300, is shown in FIG. 1. Various elements of the embodiments described herein, either individually or in combination, may be implemented on the computer system 1300. Typically the computer system 1300 includes at least one main unit coupled, directly or indirectly, to one or more output devices 1301 which transmit information or display information to one or more users or machines. The computer system 1300 is also coupled, directly or indirectly, to one or more input devices 1302 which receive input from one or more users or machines. The main unit may include one or more processors 1303 coupled, directly or indirectly, to a memory system 1304 via one or more interconnection mechanisms 1305, examples of which include a bus or a switch. The input devices 1302 and the output devices 1301 are also coupled to the processor 1303 and to the memory system 1304 via the interconnection mechanism 1305. The computer system 1300 may further comprise a storage system 1306 in which information is held on or in a non-volatile medium. The medium may be fixed in the system or may be removable.

The computer system 1300 may be a general purpose computer system which is programmable using a computer programming language. Computer programming languages suitable for implementing such a system include procedural programming languages, object-oriented programming languages, macro languages, or combinations thereof The computer system 1300 may also be specially-programmed, special-purpose hardware, or an application specific integrated circuit (ASIC).

In a general-purpose computer system, the processor 1303 is typically a commercially-available processor which executes a program called an operating system which controls the execution of other computer programs and provides scheduling, input/output and other device control, accounting, compilation, storage assignment, data management, memory management, communication and data flow control and other services. The processor and operating system define the computer platform for which application programs in other computer programming languages are written. The invention is not limited to any particular processor, operating system or programming language.

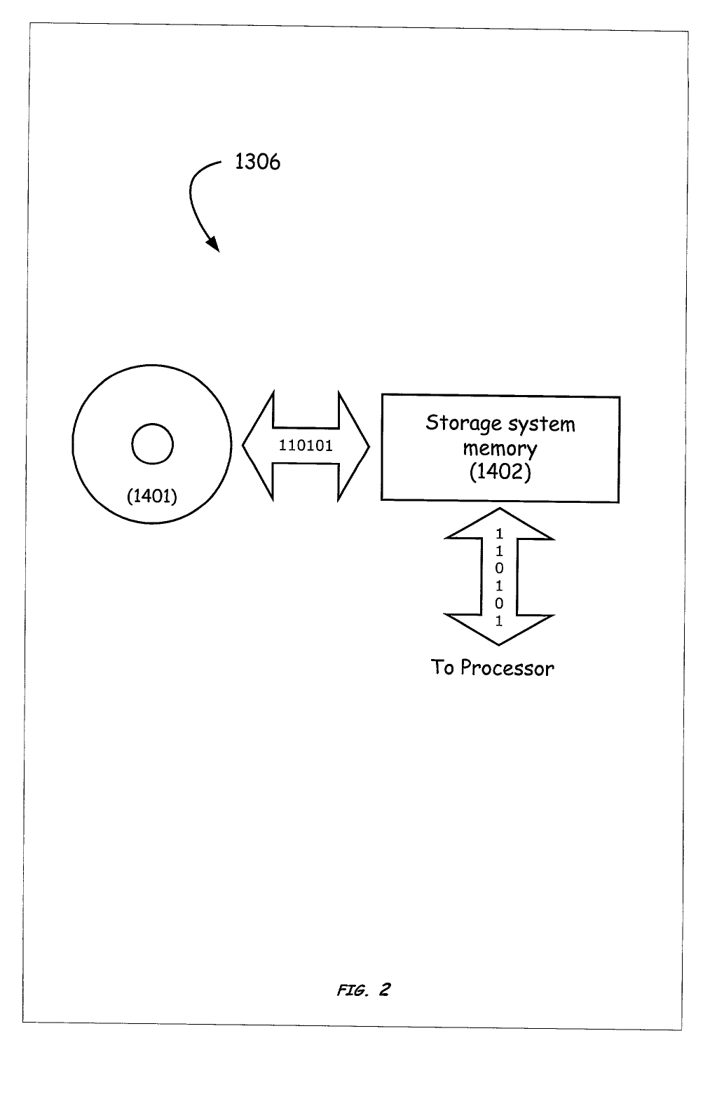

The storage system 1306, shown in greater detail in FIG. 2, typically includes a computer-readable and writeable nonvolatile recording medium 1401 in which signals are stored that define a program to be executed by the processor 1303 or information stored on or in the medium 1401 to be used by the program. The medium 1401 may, for example, be a disk or flash memory. Typically, in operation, the processor 1303 causes data to be read from the nonvolatile recording medium 1401 into another memory 1402 that allows for faster access to the information by the processor 1303 than does the medium 1401. This memory 1402 is typically a volatile, random access memory (RAM), such as a dynamic random access memory (DRAM) or static random access memory (SRAM). It may be located in storage system 1306, as shown in FIG. 2, or in memory system 1304, as shown in FIG. 1. The processor 1303 generally manipulates the data within the integrated circuit memory 1304, 1402 and then copies the data to the medium 1401 after processing is completed. A variety of mechanisms are known for managing data movement between the medium 1401 and the integrated circuit memory element 1304, 1402, and the invention is not limited thereto. The invention is also not limited to a particular memory system 1304 or storage system 1306.

Aspects of embodiments of the invention may be implemented in software, hardware, firmware, or combinations thereof. The various elements of an embodiment, either individually or in combination, may be implemented as a computer program product including a computer-readable medium on which instructions are stored for access and execution by a processor. When executed by the computer, the instructions instruct the computer to perform the various steps of the process.

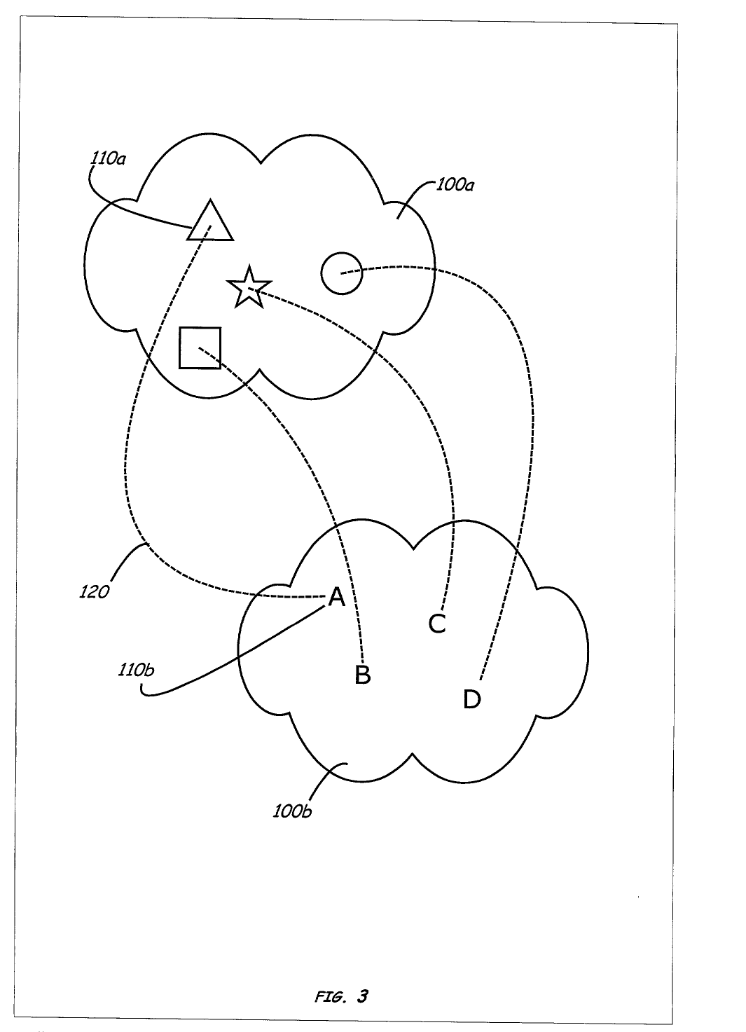

FIG. 3 shows an illustrative representation of two object sets 100A and 100B, the object sets containing various objects 110A and 11oB for example. As described previously, associations may be performed between the object sets 100 or the objects contained therein 110. An association between two objects, e.g. 110A and 110B, is depicted in the figure by A-connector 120.

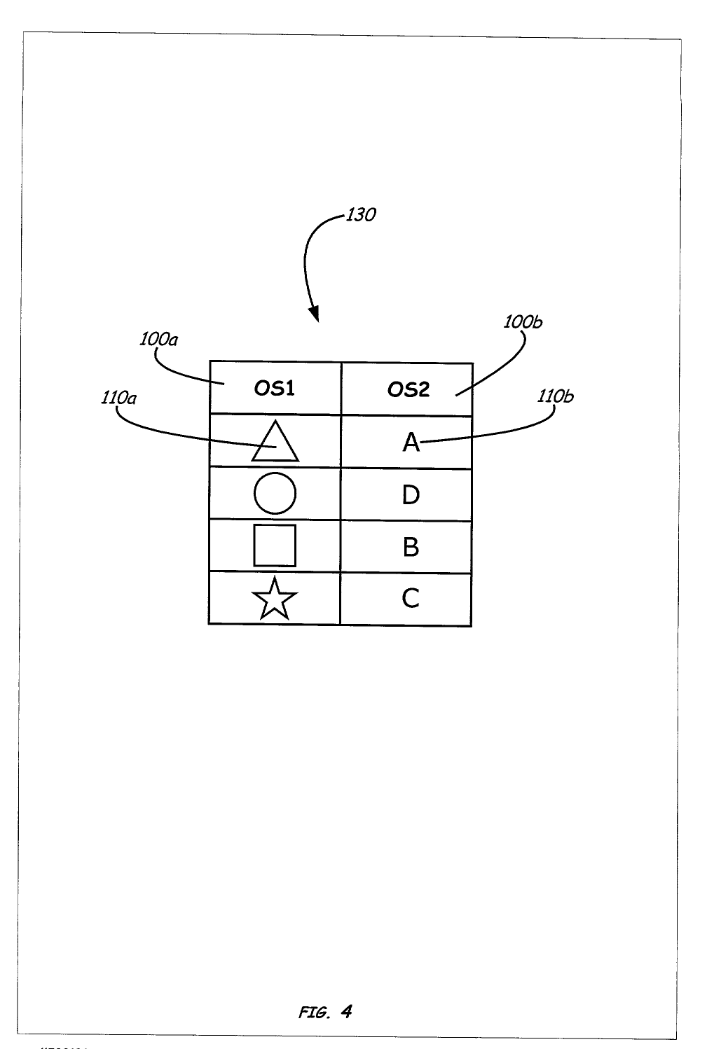

Another way to consider associations is shown schematically in FIG. 4. The figure shows a table 130 comprising elements of two object sets 100A and 100B. In the tabular representation the associations between two objects, e.g. 110A and 110B, are given by placing the objects 110A and 110B in corresponding positions of the table 130. The table 130 shown in FIG. 4 only provides the associations formed between the object sets 100A and 100B, without providing any quantitative indication of the strength of the association between the two object sets or the constituent objects therein.

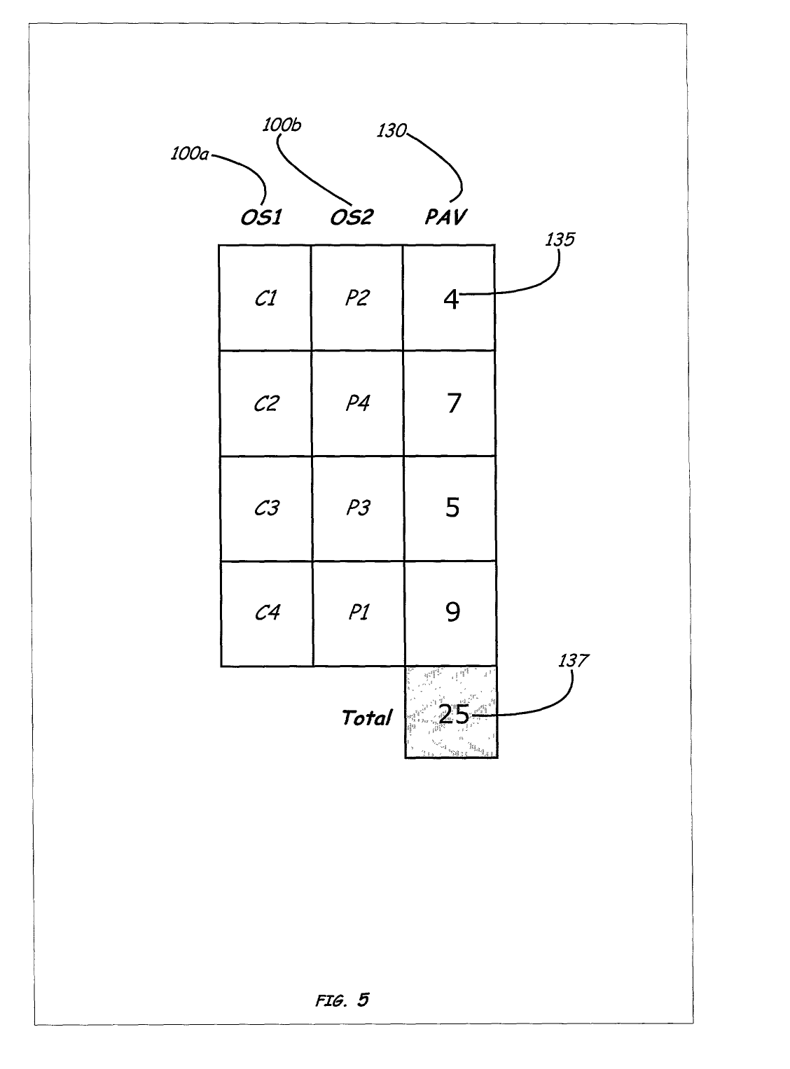

FIG. 5 shows, also by way of a table, not only the associations made between the two object sets 100A and 100B, but also provides the pair association values corresponding to each pair of objects from the two object sets which have been associated with one another. For example, FIG. 5 shows an association being made between two objects, C1 and P2, which yields a pair association value of 4. Pair association values 130 are given for each of the associations made between the various pairs of elements in sets OS1 and OS2. FIG. 5 also goes on to show a metric indicative of an overall association value between the two object sets OS1 and OS2. In this example, a sum is taken over all pair association values 130 created from associating the individual elements of the object sets OS1 and OS2. In the example shown in FIG. 3 the value of the metric is equal to (4+7+5+9)=25, which is entered into the space labeled 137.

If the object sets 100A and 100B are disposed such that a cross-space is formed thereby, then a matrix 140 may be defined over the cross-space having in one dimension a cardinality equal to the cardinality of a first object set 100A, and in the other dimension having a cardinality equal to the cardinality of the second object set 100B. Generally, a plurality of matrix elements 142 are then able to be populated with a distribution comprising data which corresponds to the pair association values formed by the objects of the object sets corresponding to the position in the matrix of a given matrix element 142. This is of course not meant by way of limitation, and any other metric may be used under suitable circumstances to populate the matrix 140.

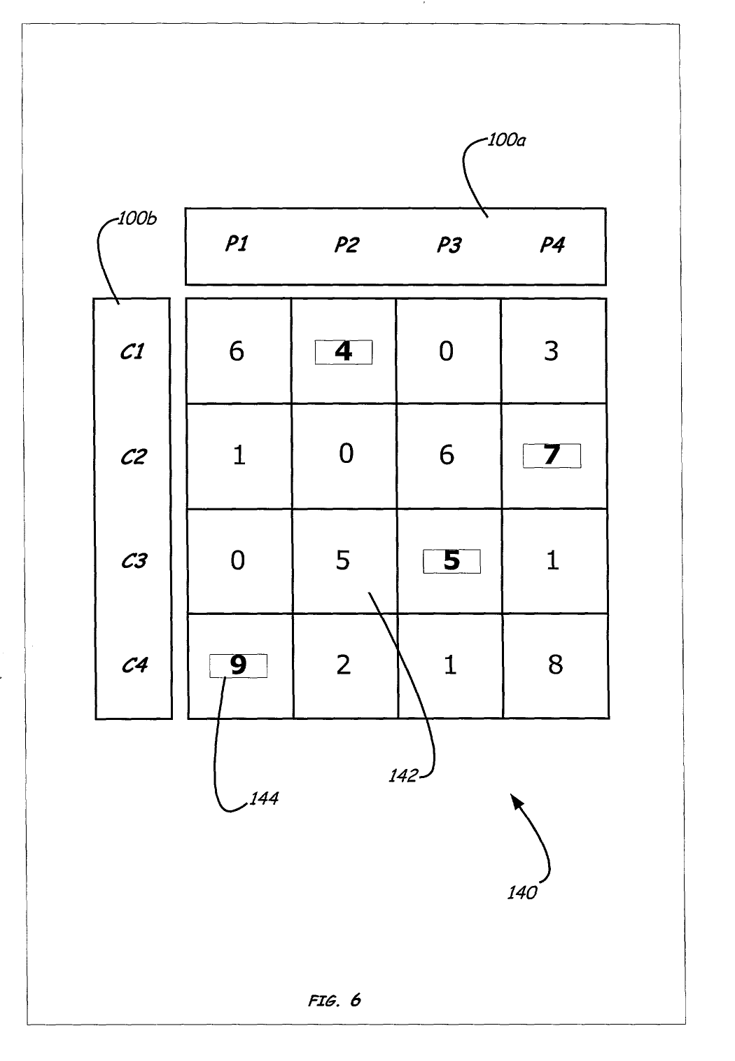

FIG. 6 shows some elements of the matrix highlighted in bold type and boxed, e.g. 144. This is meant to depict illustratively a one-to-one assignment which assigns each particular object from the first object set 100A to a corresponding particular object from the second object set 100B. For example, if the object sets 100A and 100B correspond to products (P1 . . . P4) and customers (C1 . . . C4) respectively, then the second product P2 has in this example then associated with an assigned to customer segment or object C1. Matching an assignment criteria can take on many forms as has been described, but in some embodiments the assignment is based at least on a pair association value is used for this purpose. One may then use any of various techniques, e.g. exhaustive searching or linear programming techniques to contemplate which assignments would yield an optimum or a preferred arrangement of the elements of the object sets 100A and 100B.

According to some embodiments, only a one-to-one assignment scheme is permitted, and certain arrangements or assignments were traditionally deemed inadmissible. The term “inadmissible” is meant in a limited and qualified way, mainly to indicate a difficulty in handling these types of matches in conventional matching schemes, but the present invention is not so limited and can admit these traditionally inadmissible associations.

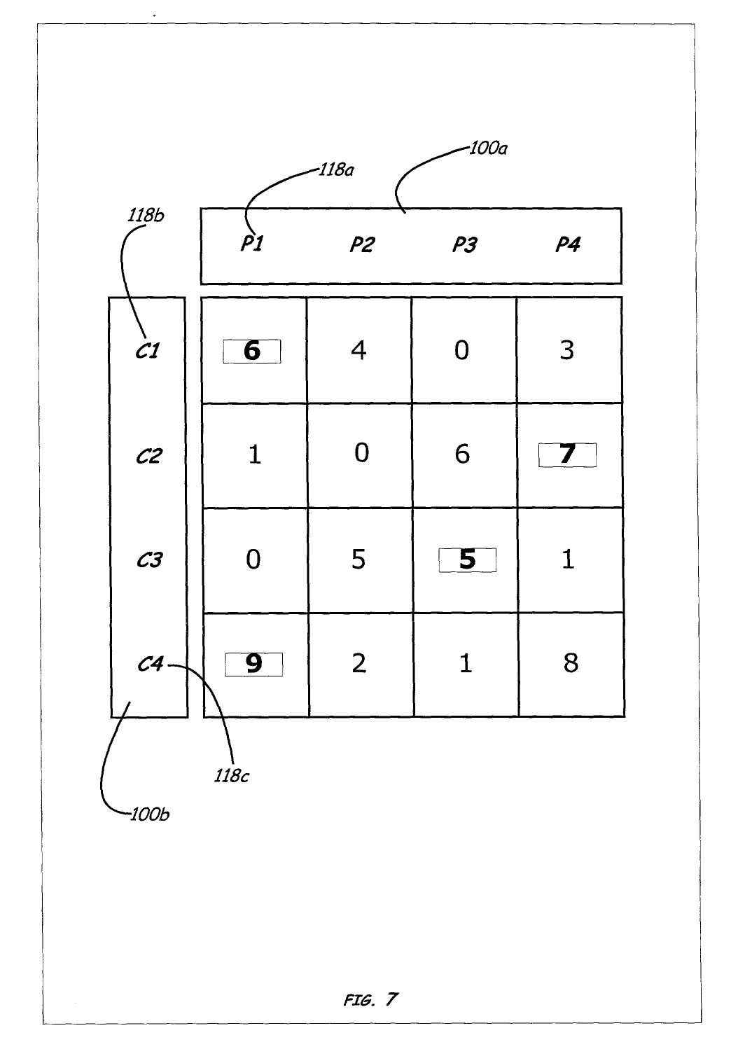

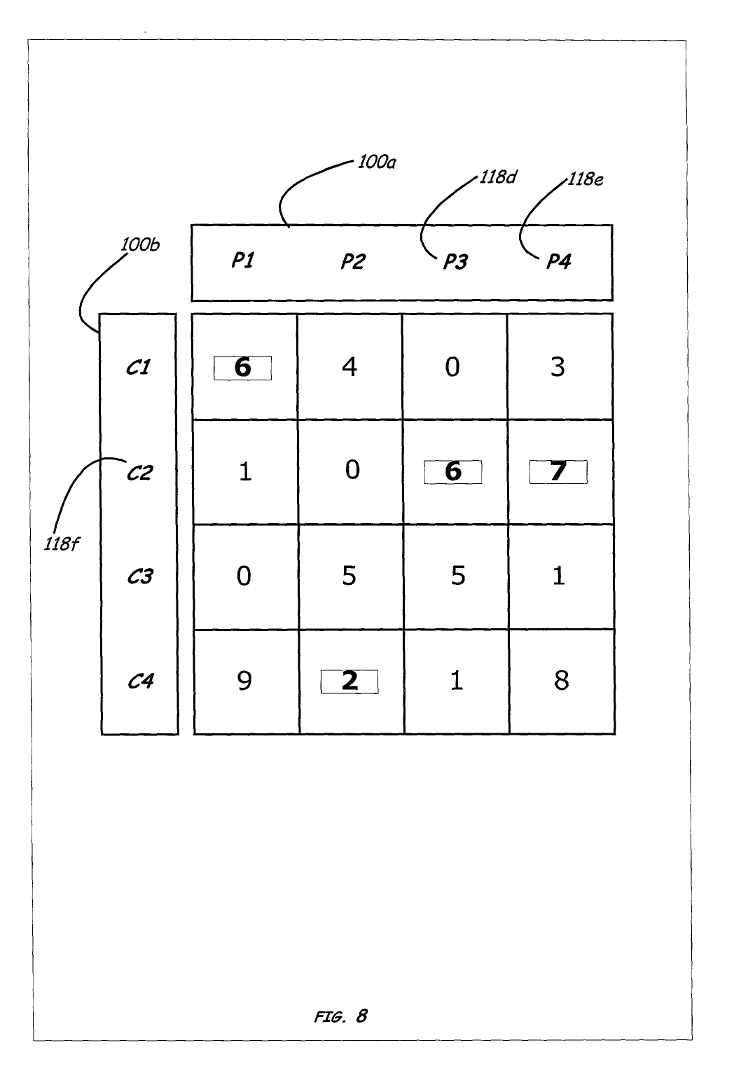

FIGS. 7 and 8 show two examples of traditionally-inadmissible assignments according to some embodiments of the present invention. In FIG. 7 a single object 118A from a first object set 100A appears to be assigned to two different objects 118B and 118C from the second object set 100B. Similarly, FIG. 8 shows an inadmissible assignment assigning two different objects 118D and 118E from the first object set 100A with a single object 118F taken from the second object set 100B.

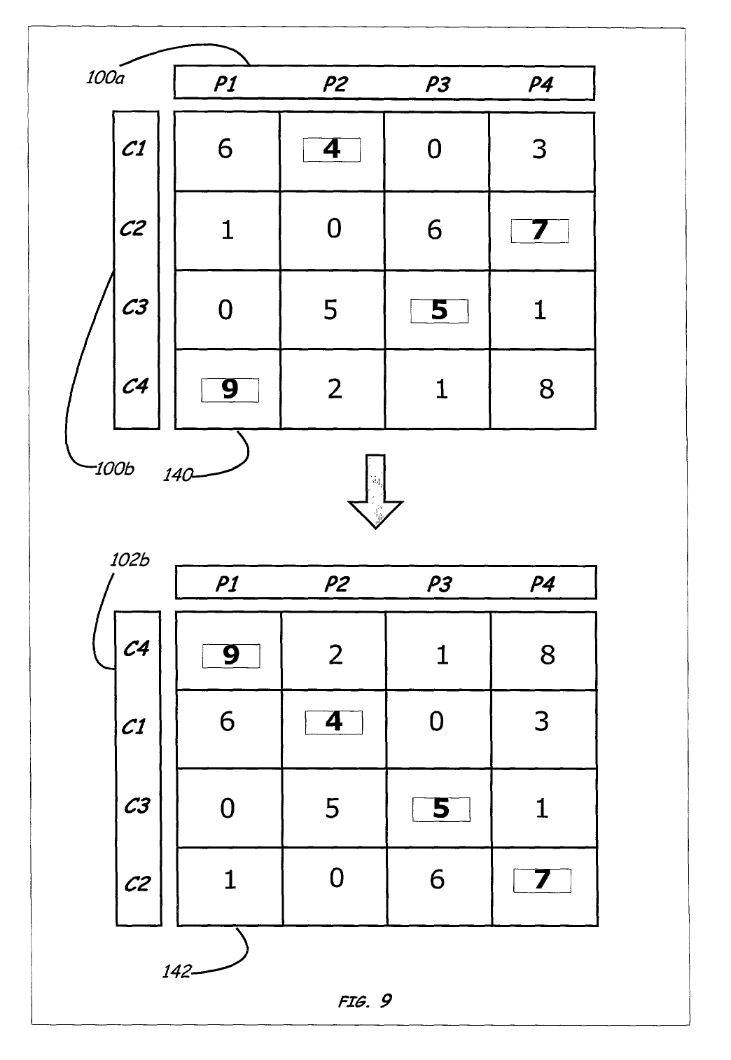

In some embodiments it is advantageous to arrange one or both object sets in a preferred arrangement. For example, to facilitate algebraic operations or calculations of values of metrics, it may be desirable to arrange particular associations or assignments of objects along a diagonal of a matrix defined by the cross-space formed by two object sets 100A and 100B. In an illustrative example, shown in FIG. 9, a permutation of the rows of matrix 140 has been accomplished. The permutation which may be implemented as an operator or a matrix multiplication operation, yields a permuted matrix 142 corresponding to a permuted object set 102B. Here, the assignments appear along the diagonal of permuted matrix 142. A metric, for example the trace of matrix 142 may then be computed in an exemplary embodiment to calculate a value of the trace metric which can be indicative of an overall association value between the object sets 100A and 100B.

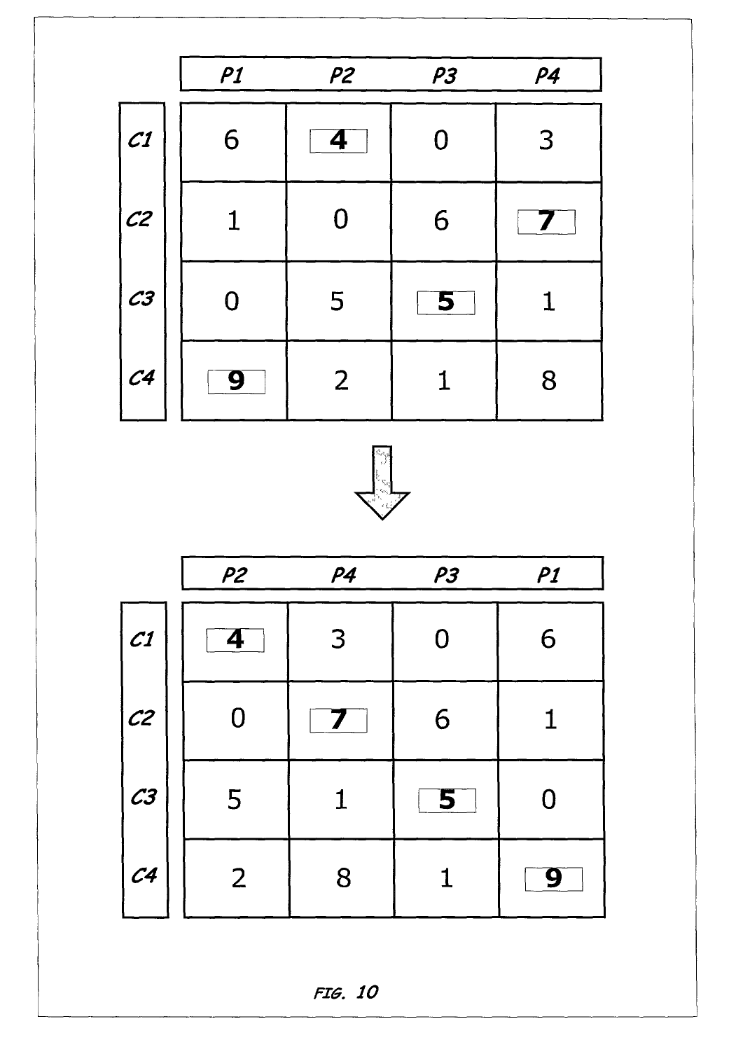

Of course the columns corresponding to elements of the first object set 100A may alternatively be permuted. This is shown in FIG. 10, where elements of the first object set 100A are permuted to form an object set 104A such that the entries corresponding to assignments between the elements of the object sets lie along a diagonal of the matrix 144. Once again a value of a metric, such as the trace of matrix 144, may be computed easily when the permuted matrix 144 is obtained.

It should be mentioned that both the columns and the rows of a matrix 140 may be permuted to obtain a desired arrangement of the elements of the matrix 140. It should also be noted that similar analogous techniques may be implemented on matrices having greater than two dimensions, such as data cubes and hypercubes, etc.

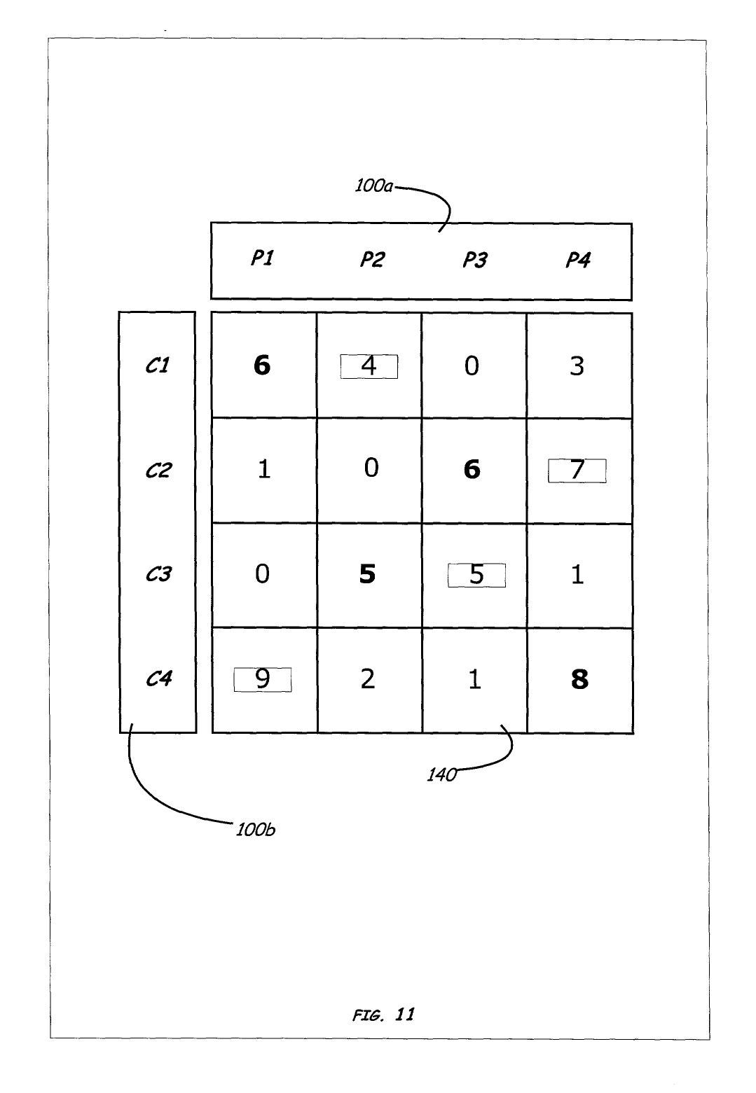

Depending on the metric used to gage an association, a preferred or optimum association may not be unique. In FIG. 11 two associations are shown, one depicted by boldface numbers in the matrix 140, the other depicted by boxed elements in the matrix 140. Both schemes for assigning elements of the first object set 100A and the second object set 100B result in a sum equal to 25 according to a metric which adds the pair association values.

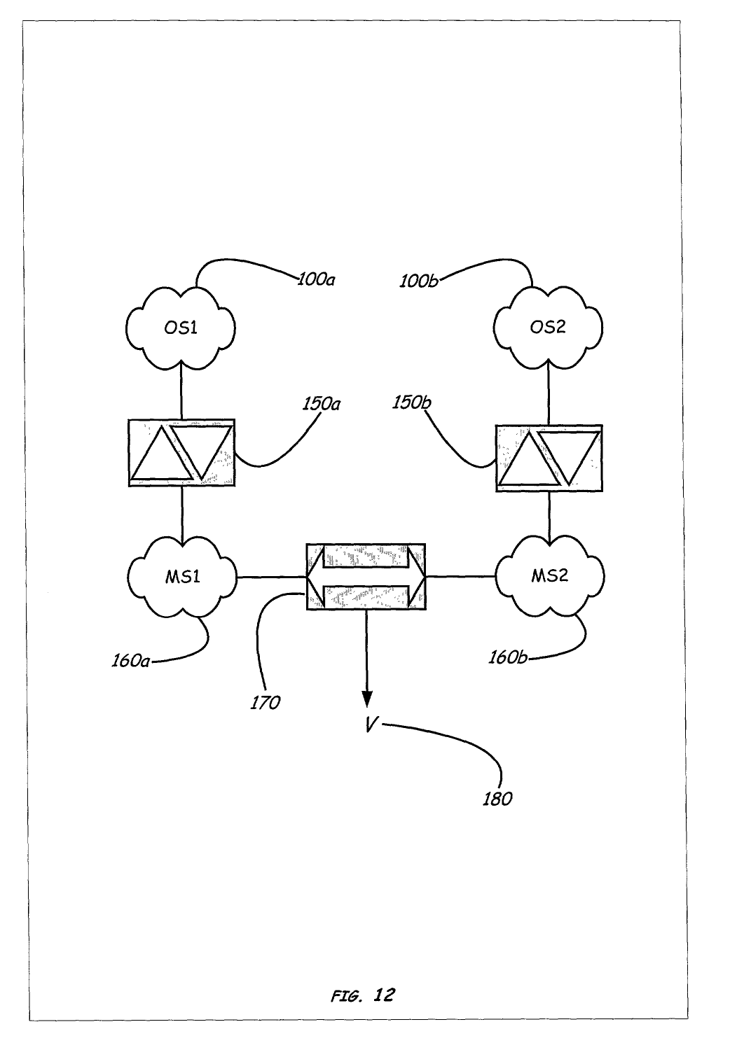

FIG. 12 shows schematically an overview of how a value of a metric is derived from associations and operations and modifications of two object sets according to some embodiments of the invention. Here object sets 100A and 100B are modified using two modifiers, 150A and 150B, operating respectively on the object sets 100A and 100B. The object sets 100A and 100B can be considered in some cases “original object sets” and may be populated in some cases with original or raw data obtained from some data collection process or mechanism. The modifiers 150A and 150B may comprise means for aggregating, refining, permuting, or otherwise expanding or reducing or reordering of the two original object sets.

The modifiers 150A perform a modification on the original object sets and yield two corresponding modified object sets 160A and 160B. The modified object sets 160A and 160B may then be associated by an associator 170 as described elsewhere in this document. The associator may perform any function in general or operation on at least an element of sets 160A and 160B to yield a value of a metric being used by the associator 170. In this example, the associator 170 may perform an association on elements of the modified object sets 160A and 160B to yield at least of one pair association value, or the associator 170 may perform an overall association operation on the entire modified object sets 160A and 160B. The associator produces an output value 180 representative of a quantification of the operation or association performed by the associator 170.

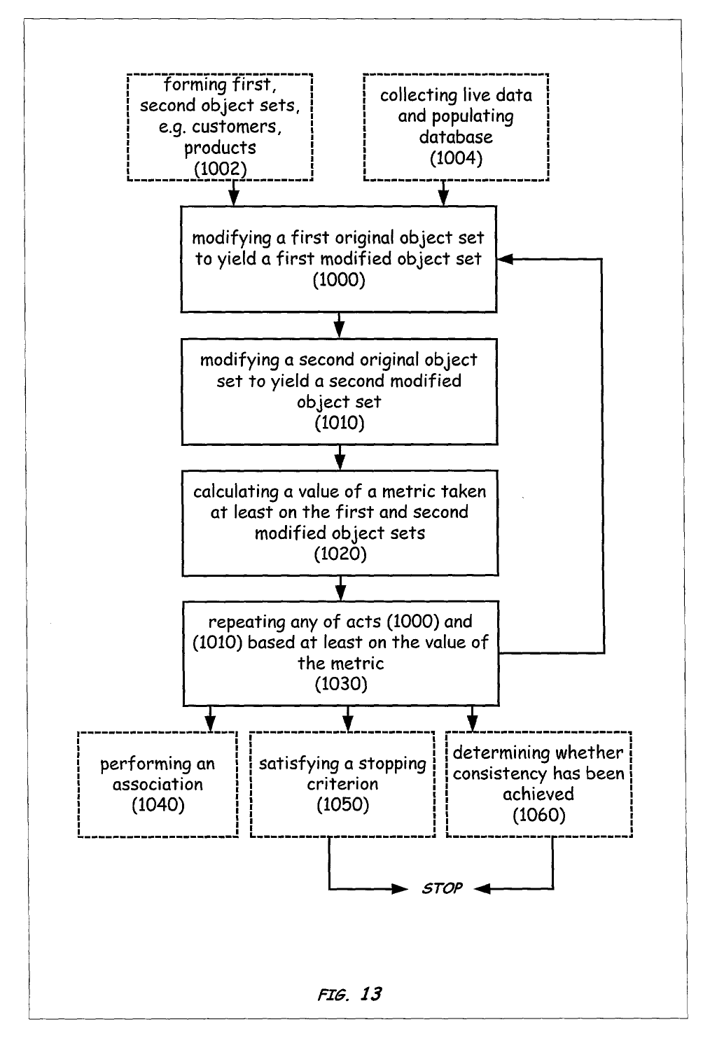

FIG. 13 shows schematically a plurality of acts, which may be carried out in any order suitable for the application, according to various embodiments of the present invention.

In acts 1004 and 1002, data is collected, which may be live data, for populating a distribution matrix or a database. Objects or categories or segments may be formed thereon or extracted therefrom to create first and second object sets, e.g. customers and products.

Acts 1000 and 1010 respectively comprise modifying a first and second original data set to yield first and second modified object sets. Next, in act 1020, a metric is used and a value of the metric is calculated at least on the first and second modified object sets.

Acts 1000 and/or 1010 are repeated as necessary, optionally in a loop which can further comprise performing act 1020 and others. This repetition is depicted in act 1030 of the figure.

Finally, a number of auxiliary acts may be performed, some of which include performing an association (1040), satisfying a stopping criterion (1050), determining whether consistency has been achieved (1060), or other acts. A stopping act is drawn to indicate exiting a loop or a repetitive process, perhaps upon achieving convergence or consistency or based on some criterion for stopping.

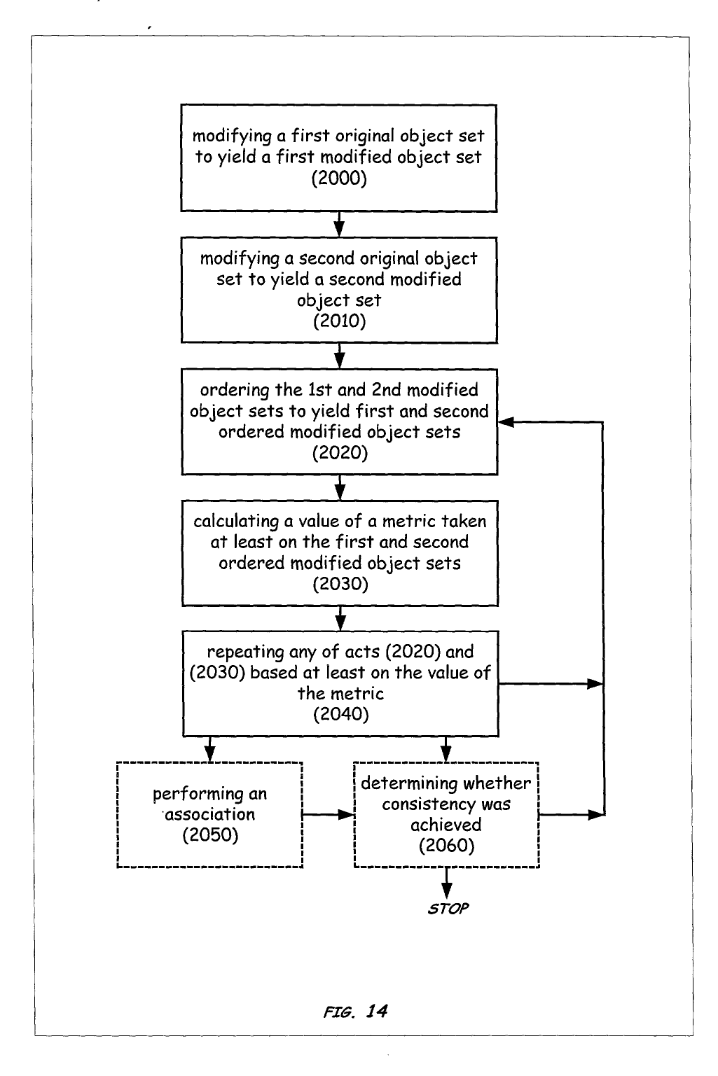

FIG. 14 shows schematically a process comprising modifying a first and second object set to yield a respective first and second modified object set in acts 2000 and 2010. Then the first and second modified object sets are ordered to yield corresponding first and second ordered modified object sets in act 2020.

Next, a value of a metric is calculated as before in act 2030, the value being a function of at least the first and second ordered modified object sets. This group of acts comprising acts 2020 and 2030 can be repeated according to the act described as 2040. Also, auxiliary acts such as performing an association (2050) and/or determining whether consistency or a stopping criterion was achieved (2060) can be accommodated, then the process ends with a stop.

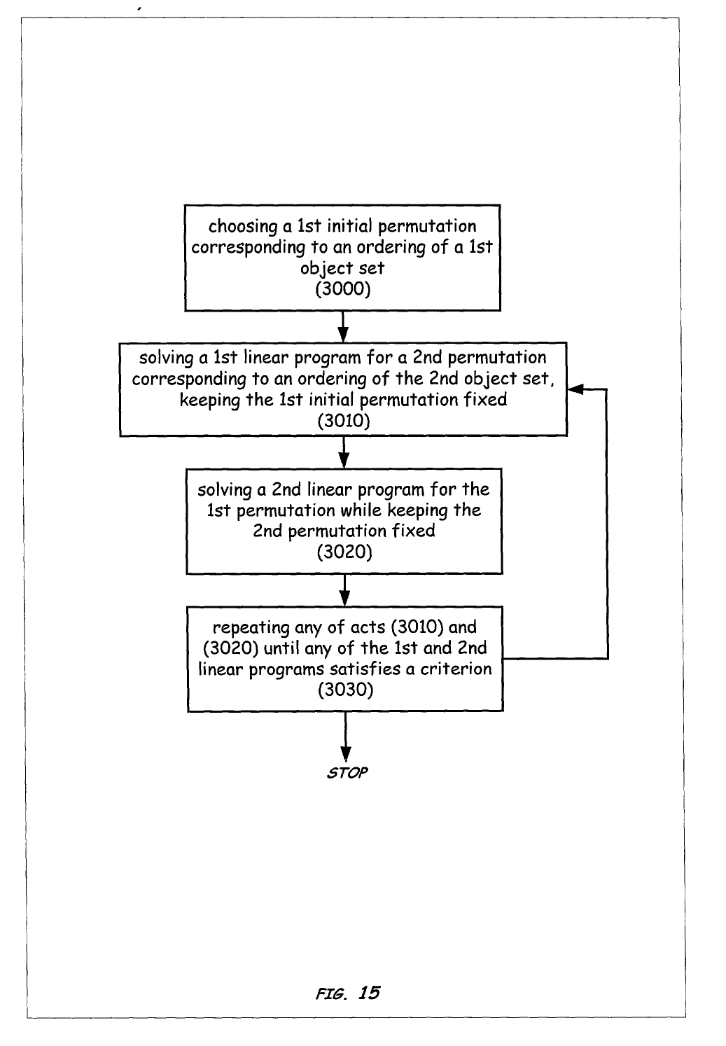

FIG. 15 illustrates schematically an embodiment of a method according to the present invention that includes solving a linear program for optimization. In act 3000, choosing a first initial permutation corresponding to an ordering of a first object set is performed. Act 3010 is directed to solving a first linear program for a second permutaion while the first permutation is held fixed. Act 3020 comprises solving a second linear program for the first permutation while keeping the second permutation fixed. Again, optionally as a way of optimizing, acts 3010 and 3020 are repeated until any of the first and second linear programs satisfies a criterion or converges, after which the process may stop.

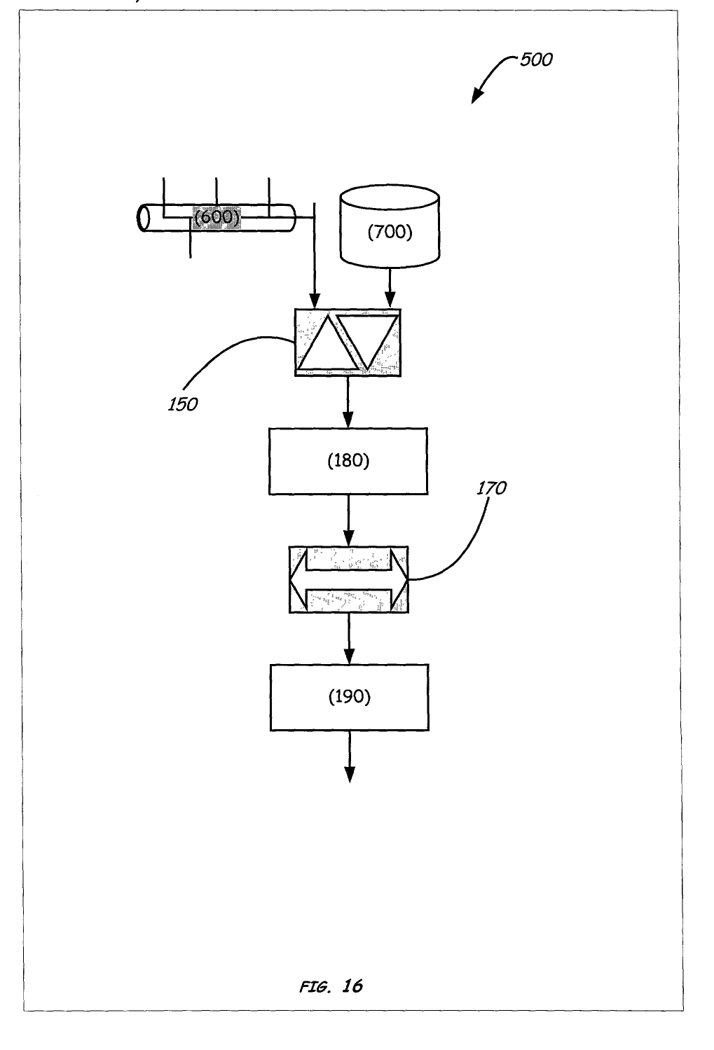

FIG. 16 depicts an illustrative of an embodiment of a system 500 according to the present invention. Data may be obtained either from a storage site or database 700 or from a live source such as a network 600. The data is put into object sets such as by using a data processor shown in FIG. 1 earlier. The object sets are acted on using the modifier 150, which couples the data sources 600, 700 to a calculator 800 that calculates a metric taken on at least the object sets. Optionally, an associator 170 may be used, such as an aggregator, refiner or permuter to perform an association of the object sets or information related thereto. Additionally, the system 500 includes a means 190 for determining whether a function of the value of the metric is consistent.

Having thus described at least one illustrative embodiment of the invention, various alterations, modifications and improvements will become apparent to those skilled in the art. Such alterations, modifications, and improvements are intended to be part of this disclosure, and are intended to be within the spirit and scope of the invention. Accordingly, the foregoing description is by way of example only and is limited only as defined in the following claims and the equivalents thereto.

1. A method of determining a preferred grouping scheme, comprising:
(A) modifying a first original object set to yield a first modified object set, wherein the first original object set and the first modified object set are of different cardinalities;
(B) modifying a second original object set to yield a second modified object set;
(C) calculating a value of a metric taken at least on the first and second modified object sets; and
(D) repeating any of (A) and (B) based at least on the value of the metric.

2. The method of claim 1 wherein the second original object set and the second modified object set are of different cardinalities.

3. The method of claim 1, wherein (A) comprises aggregating and a cardinality of the first modified object set is less than a cardinality of the first original object set.

4. The method of claim 1, wherein (A) comprises refining and a cardinality of the first modified object set is greater than a cardinality of the first original object set.

5. The method of claim 1, wherein (A) comprises both aggregating and refining.

6. The method of claim 1, further comprising:
(E) associating at least one element of the first modified object set with at least one element of the second modified object set.

7. The method of claim 1, wherein (C) comprises calculating a pair association value corresponding to an association between at least one element of the first modified object set and at least one element of the second modified object set.

8. The method of claim 1, further comprising:
(E) associating the first modified object set and the second modified object set.

9. The method of claim 1, wherein (C) comprises calculating an overall association value corresponding to an association between the first modified object set and the second modified object set.

10. The method of claim 9, wherein the overall association value is a function of at least one pair association value.

11. The method of claim 1, wherein the value of the metric is optimal with respect to a set of admissible functions of the first and second modified object sets.

12. The method of claim 11, wherein a value of the admissible functions comprise admissible associations between at least one element of the first modified object set and at least one element of the second modified object set.

13. The method of claim 1, wherein the original object sets comprise categories of categorical data sets.

14. The method of claim 1, further comprising:
(E) converting elements of any object set from a first type of objects to a second type of objects.

15. The method of claim 1, wherein the first and second original object sets are identical.

16. The method of claim 1, further comprising:
(E) determining whether any of the first and second modified object sets has converged.

17. The method of claim 1, further comprising:
(E) determining whether a matrix defined by a cross-space of the first and second modified object sets has converged.

18. The method of claim 1, further comprising:
(E) determining whether a function of a matrix defined by a cross-space of the first and second modified object sets has converged.

19. The method of claim 18, wherein (E) comprises determining whether a pair association value corresponding to an association between at least one element of the first modified object set and at least one element of the second modified object set has converged.

20. The method of claim 18, wherein (E) comprises determining whether an overall association value corresponding to an association between the first and second modified object sets has converged.

21. The method of claim 1, further comprising:
(E) determining whether a permutation, signifying an ordering, of any of the first and second modified object sets has converged.

22. The method of claim 1, wherein a matrix defined by a cross-space of the first and second original object sets is populated with live data such that the matrix is dynamic.

23. The method of claim 1, wherein (C) comprises calculating a value of a metric taken on a matrix, wherein the matrix defined by a cross-space formed by the first and second modified object sets and, wherein the metric is a linear arithmetic operation on a plurality of elements of the matrix.

24. The method of claim 23, wherein the operation comprises a trace.

25. The method of claim 1, wherein the first original object set comprises elements corresponding to groups of customers and the second original object set comprises elements corresponding to groups of products.

26. A method of determining a preferred grouping scheme, comprising:
(A) modifying a first original object set to yield a first modified object set, wherein the first original object set and the first modified object set are of different cardinalities;
(B) modifying a second original object set to yield a second modified object set;
(C) ordering the first and second modified object sets to yield respective first and second ordered modified object sets;
(D) calculating a value of a metric taken at least on the first and second ordered modified object sets; and
(E) repeating any of (C) and (D) based at least on the value of the metric.

27. The method of claim 26, further comprising:
(F) repeating any of (A) and (B) based at least on the value of the metric.

28. A method of determining a preferred grouping scheme, comprising:
(A) modifying a first original object set to yield a first modified object set, wherein the first original object set and the first modified object set are of different cardinality;
(B) modifying a second original object set to yield a second modified object set;
(C) calculating a value of a metric taken at least on the first and second modified object sets; and
(D) repeating (A), (B) and (C) until a stopping criterion is satisfied.

29. The method of claim 28, wherein the stopping criterion is a function of the value of the metric.

30. A method of associating objects, comprising:
(A) associating at least one element of a first object set with at least one element of a second object set; and
(B) checking whether an association obtained in (A) yields a consistent outcome.

31. The method of claim 30, wherein (B) comprises checking whether a function of the association is consistent.

32. The method of claim 30, wherein the association in (B) is consistent.

33. The method of claim 30, wherein (B) comprises checking whether at least one element of a matrix defined over a cross-space of the first and second object sets is consistent.

34. The method of claim 30, wherein the first and second object sets are obtained by:
(C) modifying a first original object set to yield the first object set; and
(D) modifying a second original object set to yield the second object set.

35. The method of claim 34, wherein (B) comprises checking whether any of the first and second object sets is consistent.

36. The method of claim 34, wherein the objects comprise live data collected dynamically by a data processing system.

37. The method of claim 34, wherein (D) comprises checking whether a cost metric has reached a sufficiently stable value to be considered consistent.

38. The method of claim 34, wherein (D) comprises checking whether an object set has reached a sufficiently stable composition to be considered consistent.

39. The method of claim 34, wherein (D) comprises checking whether an association between particular sets of elements of two object sets has reached a sufficiently stable value to be considered consistent.

40. The method of claim 34, wherein (D) comprises checking whether associations between substantially all elements of two object sets have reached sufficiently stable values to be considered consistent.

41. A method of determining a preferred grouping scheme, comprising:
(A) modifying a first original object set to yield a first modified object set;
(B) modifying a second original object set to yield a second modified object set;
(C) calculating a value of a metric given by a non-commutative function of at least the first and second modified object sets; and
(D) repeating any of (A) and (B) based at least on the value of the metric.

42. The method of claim 41, wherein the non-commutative function has a range which (i) is not spanned by an image of a set of admissible modifications of the first original object set through the non-commutative function while fixing a modification of the second original object set, and (ii) is not spanned by an image of a set of admissible modifications of the second original object set through the non-commutative function while fixing a modification of the first original object set.

43. The method of claim 41, wherein (A) and (B) comprise permuting the first and second original object sets, respectively.

44. The method of claim 41, wherein (A) comprises aggregating and a cardinality of the first modified object set is less than a cardinality of the first original object set.

45. The method of claim 41, wherein (A) comprises refining and a cardinality of the first modified object set is greater than a cardinality of the first original object set.

46. The method of claim 41, wherein (A) comprises both aggregating and refining.

47. A method of obtaining a preferred ordering of a first and a second object set, the first and second object sets having a cross-space defining a matrix H, the method comprising:
(A) choosing a first initial permutation, P1, corresponding to an ordering of the first object set;
(B) solving a first linear program, max[ƒ(P1, H, P2)]=G1, for a second permutation, P2, corresponding to an ordering of the second object set while keeping P1 fixed;
(C) solving a second linear program, max[ƒ(P1, H, P2)]=G2, for P1 while keeping P2 fixed; and
(D) repeating (B) and (C) until any of G1 and G2 satisfies a predetermined convergence criterion.

48. The method of claim 47, wherein the matrix H is a matrix representing a distribution over the cross-space of the first and second object sets.

49. The method of claim 47, wherein P1 and P2 are matrices and (P1 H P2) represents a matrix multiplication and f is a function defined on (P1 HP 2).

50. The method of claim 47, wherein P1 is an aggregation matrix whose elements are either zeroes or ones and whose columns each sums to exactly 1 and whose rows each sums to a value greater or equal to 1.

51. The method of claim 47, wherein P2 is an aggregation matrix whose elements are either zeroes or ones and whose rows each sums to exactly 1 and whose columns each sums to a value greater or equal to 1.

52. A storage medium on which are coded instruction, which when executed on a data processing system cause the data processing system to:
(A) modify a first original object set to yield a first modified object set, wherein the first original object set and the first modified object set have different cardinalities;
(B) modify a second original object set to yield a second modified object set;
(C) calculate a value of a metric taken at least on the first and second modified object sets; and
(D) repeat any of (A) and (B) based at least on the value of the metric.

52. A system that performs associations on object sets, comprising:
a modifier that modifies a first original object set and a second object set to yield a first modified object set and a second modified object set;
a calculator that calculates a value of a metric taken on at least the first and second modified object sets; and
means for determining whether a function of the value of the metric is consistent.

53. The system of claim 52, wherein the modifier is an aggregator that aggregates a subset of any of the first and second original object sets to yield a corresponding first and second aggregated object sets.

54. The system of claim 52, wherein the modifier is a refiner that refines a subset of any of the first and second original object sets to yield a corresponding first and second refined object sets.

55. The system of claim 52, wherein the modifier is a permuter that permutes a subset of any of the first and second original object sets to yield a corresponding first and second permuted object.

56. The system of claim 52, wherein the calculator calculates the function as a trace of a matrix defined by a cross-space formed by the first and second modified object sets.

57. The system of claim 52, wherein the value of the metric is an association value.

58. A method of associating objects, comprising:
(A) associating at least one element of a first original object set with at least one element of a second original object set;
(B) modifying elements of the first original object set, producing thereby a first modified object set;
(C) modifying elements of the second original object set, producing thereby a second modified object set; and
(D) associating at least one element of the first modified object set with at least one element of the second modified object set.

59. The method of claim 58, wherein (B) comprises aggregating elements of the first original object set, producing thereby a first aggregated object set.

60. The method of claim 58, wherein (C) comprises aggregating elements of the second original object set, producing thereby a second aggregated object set.

61. The method of claim 58, wherein the first original object set has a first original number of elements and the second original object set has a second original number of elements, and wherein the first aggregated object set has a first modified number of elements and the second aggregated object set has a second modified number of elements.

62. The method of claim 61, wherein the first modified number of elements is less than or equal to the first original number of elements, and wherein the second modified number of elements is less than or equal to the second original number of elements.

63. The method of claim 58, further comprising computing a pair association value between the at least one element of the first aggregated object set and the at least one element of the second aggregated object set.

64. The method of claim 58, further comprising computing an overall association value corresponding to an overall match between the first and second original object sets.

65. The method of claim 58, further comprising computing an overall association value corresponding to an overall match between the first and second aggregated object sets.

66. The method of claim 58, further comprising, following (A):
(E) calculating a pair association value representative of a metric corresponding to an association between the at least one element of the first original object set and the at least one element of the second original object set.

67. The method of claim 58, further comprising.
(E) optimizing an association between the first and second original object sets.

68. The method of claim 58, further comprising, following (A):
(E) calculating an overall association value representative of a metric corresponding to an association between the first and second original object sets.

69. The method of claim 68, wherein the overall association value is an optimal association over a plurality of possible associations of the first and second original object sets.

70. The method of claim 58, wherein the grouping of the elements of the first original object set in (B) yields a first aggregated object set whose association with the second aggregated object set yields an optimum overall association value.

71. The method of claim 58, further comprising, following (D):
(E) calculating a pair association value representative of a metric corresponding to an association between the at least one element of the first aggregated object set and the at least one element of the second aggregated object set.

72. The method of claim 58, further comprising.
(E) optimizing an association between the first and second aggregated object sets.

73. The method of claim 58, further comprising, following (D):
(E) calculating an overall association value representative of a metric corresponding to an association of the first and second aggregated object sets.

74. The method of claim 73, wherein the overall association value is an optimal association over a plurality of possible associations of the first and second aggregated object sets.

75. The method of claim 73, wherein the overall association value is represented by a number.

76. The method of claim 58, wherein the objects comprise live data collected dynamically by a data processing system.

77. The method of claim 58, wherein the first and second original object sets are identical.

78. The method of claim 58, wherein the first and second aggregated object sets are identical.

79. The method of claim 58, wherein any of (A) and (B) comprises operating on any of the first and second original object sets using an aggregation set which operates on the same any of the first and second original object sets by way of an operator.

80. The method of claim 79, wherein the aggregation set is a matrix.

81. The method of claim 79, wherein act of operating on any of the first and second original object sets comprises matrix multiplication.

82. The method of claim 58, wherein at least one element of the first original object set and at least one element of the second original object set are not associated with one another.

83. The method of claim 58, wherein at least one element of the first aggregated object set and at least one element of the second aggregated object set are not associated with one another.

84. The method of claim 58, wherein at least one element of the first aggregated categorical data set and at least one element of the second aggregated categorical data set are not associated with one another.

85. The method of claim 58, further comprising:
(E) grouping elements of a third original object set, producing thereby a third aggregated object set; and
(F) associating at least one element of the third aggregated object set with an element of any of the first and the second aggregated object sets.

86. The method of claim 58, further comprising.
(E) checking whether any of the object sets and associations thereof are consistent.

87. The method of claim 86, wherein (E) comprises checking whether a cost metric has reached a sufficiently stable value to be considered consistent.

88. The method of claim 86, wherein (E) comprises checking whether an object set has reached a sufficiently stable composition to be considered consistent.

89. The method of claim 86, wherein (E) comprises checking whether an association between particular sets of elements of two object sets has reached a sufficiently stable value to be considered consistent.

90. The method of claim 86, wherein (E) comprises checking whether associations between substantially all elements of two object sets have reached sufficiently stable values to be considered consistent.

91. The method of claim 58, further comprising:
(E) providing an output representing an association model indicative of a preferred association between the first aggregated object set and the second aggregated object set.

92. The method of claim 91, wherein the association model approximates a tendency distribution.

93. A method of associating objects, comprising:
(A) segmenting a first object set into a first plurality of object subsets;
(B) segmenting a second object set into a second plurality of object subsets;
(C) associating at least one element of the first plurality of object subsets with at least one element of the second plurality of object subsets using an association operation; and
(D) checking whether the association operation is consistent.

94. The method of claim 93, wherein the objects comprise live data collected dynamically by a data processing system.

95. The method of claim 93, wherein (D) comprises checking whether a cost metric has reached a sufficiently stable value to be considered consistent.

96. The method of claim 93, wherein (D) comprises checking whether an object set has reached a sufficiently stable composition to be considered consistent.

97. The method of claim 93, wherein (D) comprises checking whether an association between particular sets of elements of two object sets has reached a sufficiently stable value to be considered consistent.

98. The method of claim 93, wherein (D) comprises checking whether associations between substantially all elements of two object sets have reached sufficiently stable values to be considered consistent.

99. A method of associating live data, collected by a data processing system, the method comprising:
(A) sequentially receiving the live data in discrete packets;
(B) placing the live data from (A) into at least one dynamic data set;
(C) augmenting the at least one dynamic data set with new live data as the new live data is received according to (A);
(D) forming at least two categorical data sets from the elements of the at least one dynamic data set;
(E) segmenting a first categorical data set into a first plurality of categorical data subsets;
(F) segmenting a second categorical data set into a second plurality of categorical data subsets; and
(G) associating at least one element of the first plurality of categorical data subsets with at least one element of the second plurality of categorical data subsets using an association operation.

100. The method of claim 99, further comprising:
(H) grouping elements of the at least two categorical data sets, producing thereby at least two corresponding aggregated categorical data sets.

101. The method of claim 99, further comprising:
(H) checking whether the association operation is consistent.

102. A method for approximating a tendency distribution corresponding to raw data from a plurality of object sets, comprising:
(A) preconditioning the raw data into a form suitable for association;
(B) segmenting the raw data into at least two fine-level subsets;
(C) performing a first association operation between the at least two fine-level subsets;
(D) aggregating the fine-level subsets to coarse-level subsets corresponding to the fine-level subsets;
(E) performing a second association operation between the at least two coarse-level subsets; and
(F) comparing results from the first association operation and the second association operations.

103. The method of claim 102, further comprising: repeating acts (B) through (F), wherein the coarse-level subsets in (D) are redefined as fine-level subsets as in (C).

104. The method of claim 102, wherein the raw data is numerical data.

105. The method of claim 102, wherein the raw data is ordinal data.

106. The method of claim 102, wherein the raw data is categorical data.

107. The method of claim 102, wherein (A) comprises generating categorical data sets corresponding to the raw data.

108. An information filtering system comprising:
a profile subsystem for defining a space of profile data with a particular taxonomy, and for identifying users into a particular partition or category of this predefined taxonomy;
a manipulatable collaboration subsystem, based on feedback of site usage and a popular decision rule, for identifying a particular suite of content data and delivery scheme to associate with each partition in the profile taxonomy;
a content delivery subsystem for delivering particular content in combinations, sequences, and schemes as decided by the collaboration subsystem; and
a visualization and analysis subsystem for engaging projections of the collaboration subsystem by either profile-based category or content-based scheme, including category and content indicators indicating other profiles or content that is similar to the object of analysis.

109. The system of claim 108, wherein the collaboration subsystem is manipulatable by injecting predefined associations of content data and delivery schemes with particular profile categories resulting in at least:
(A) a clear benchmark to measure value of the system by comparing usage resulting from the engine to that of usage resulting from an analysts best prediction of users' preferences; and
(B) a method of measuring market elasticity by injecting price differences in the engine at various intervals and observing the resulting site behavior.

110. The system of claim 108, wherein the collaboration subsystem defines a predictive model of consumer behavior and can be used to simulate market dynamics to facilitate predictive analysis.

111. A method for conducting electronic commerce, comprising:
(A) segmenting a customer base into a plurality of customer segments based on a set of customer attributes;
(B) segmenting a product base into a plurality of product segments based on a set of product attributes;
(C) matching a customer segment and a product segment based on a plurality of commercial activity events;
(D) creating a matrix of customer segments and product segments containing information from joint correlation operations; and
(E) providing the information in the matrix in a manner usable for making marketing decisions in an electronic commerce system.

112. The method of claim 111, wherein the matrix is multidimensional.

113. The method of claim 111, wherein the segments are defined dynamically.

114. A method for deriving correspondence between two interactive data sets, comprising:
(A) dividing a first data set into a plurality of first data set segments;
(B) dividing a second data set into a plurality of second data set segments;
(C) evaluating a joint distribution matrix to determine a relevance indicator for indicating relative relevance of the first and second data set segments to one another;
(D) subdividing the first and second data set segments into finer segments and performing act (C) on the finer segments;
(E) aggregating the data set segments into coarser data set representations having fewer segments if the relevance indicator indicates a lack of relevance between the first and second data set segments; and
(F) exiting the process when the relevance indicator meets a preset condition.
